(19) United States
(12) Patent Application Publication
(10) Pub. No.: US 2024/0424410 A1
(43) Pub. Date: Dec. 26, 2024

(54) NON-TRANSITORY COMPUTER-READABLE STORAGE MEDIUM HAVING GAME PROGRAM STORED THEREIN, GAME SYSTEM, AND GAME PROCESSING METHOD

(71) Applicant: Nintendo Co., Ltd., Kyoto (JP)

(72) Inventors: Ayano MASAKI, Kyoto (JP); Ryuhei MATSUURA, Kyoto (JP); Shiro MOURI, Kyoto (JP); Shigeyuki ASUKE, Kyoto (JP); Hajime NAKAO, Kyoto (JP); Koichi HAYASHIDA, Kyoto (JP); Moe SHIRATAKI, Kyoto (JP); Terumasa KATO, Kyoto (JP); Tatsuya SAKAI, Kyoto (JP); Jun TSUZUKI, Kyoto (JP)

(21) Appl. No.: 18/747,028

(22) Filed: Jun. 18, 2024

(30) Foreign Application Priority Data
Jun. 20, 2023 (JP) 2023-101001

(51) Int. Cl. A63F 13/69; A63F 13/497; A63F 13/52; A63F 13/55

(52) U.S. Cl. CPC A63F 13/69; A63F 13/497; A63F 13/52; A63F 13/55

(57) ABSTRACT

When a mistake occurs in a game stage, if another player object exists within a predetermined range, a player object is shifted to a special state where the player object does not become damaged. While the player object is in the special state, if the player object comes into contact with another player object or a placement object placed in the game stage by the other player object, the player object is returned from the special state to a normal state. On the other hand, if the player object fails to come into contact with either the other player object or the placement object, play of the game stage is terminated.

### CROSS REFERENCE TO RELATED APPLICATION

This application claims priority to Japanese Patent Application No. 2023-101001 filed on Jun. 20, 2023, the entire contents of which are incorporated herein by reference.

### FIELD

The present disclosure relates to multiplayer game processing.

### BACKGROUND AND SUMMARY

Hitherto, a game system for playing a multiplayer game has been known. This game can be simultaneously played by up to four players on a single game apparatus. In this game, a player character can come into a state called “bubble” in which the player character temporarily does not become damaged. Then, by bringing a certain player character into a “bubble” state, play, in which a difficult area is left to another player and this player character is carried while still being in the “bubble” state, is enabled.

However, for a player who desires to advance forward, there is a situation in which this player needs to wait for another player to catch up to where this player has advanced, for example, for helping the other player. Therefore, there is a possibility that the player will feel that the tempo at which the game proceeds becomes slow. In other words, there is a possibility that their own play may be disturbed by another player.

In view of the above, the following configuration examples are exemplified.

### (Configuration 1)

Configuration 1 is directed to a non-transitory computer-readable storage medium having stored therein a game program executed by a processor of a game apparatus for executing a process of generating a game stage including a player object controllable to move on the basis of an operation by a player and another player object controlled to move on the basis of information received from another game apparatus connected via a network, the game program causing the processor to: when a mistake occurs in a predetermined game stage, shift the player object to a special state where the player object does not become damaged in the game stage; return the player object from the special state to a normal state where the player object can become damaged in the game stage, without terminating play of the game stage, if the player object comes into contact with any revival assistance object including the other player object and a placement object placed in the game stage by the other player object, while the player object is in the special state; and terminate the play of the game stage if the player object has not come into contact with any revival assistance object while the player object is in the special state.

According to the above configuration, the player object can be revived from the special state to the normal state not only by the other player object but also by the placement object placed by another player. Accordingly, even in a situation in which the player object and the other player object are far apart, it is possible to help in the above revival indirectly by using the placement object. Therefore, if the placement object is placed, even if the other player object for which the mistake has occurred is far away from the player object, the player does not have to go to help in particular, and can advance the play at their own pace.

### (Configuration 2)

In Configuration 2 based on Configuration 1 above, the player object may not be returned to the normal state if the player object in the special state comes into contact with the placement object placed by the player object.

According to the above configuration, the difficulty level of the game can be made appropriate and a decrease in entertainment characteristics can be suppressed.

### (Configuration 3)

In Configuration 3 based on Configuration 1 above, the game program may further cause the processor to: transmit placement information including at least position information of the placement object, to the predetermined server when the player object places the placement object; and place the placement object based on the placement information stored in the predetermined server, in the game stage, and the revival assistance object may include the placement object placed on the basis of the placement information stored in the predetermined server.

According to the above configuration, even if no other player object is present in the same game stage, the placement object can be placed. In addition, the player object can also be revived from the special state to the normal state using the placement object, so that the convenience of the player can be improved.

### (Configuration 4)

In Configuration 4 based on Configuration 3 above, the placement object placed on the basis of the placement information stored in the predetermined server may not function as the revival assistance object when placed, and a function of the placement object as the revival assistance object may be activated when the player object comes into contact with the placement object.

According to the above configuration, the game balance can be optimized by performing control such that the placement object does not function as the revival assistance object at first. In addition, it is possible to provide play in which the placement object placed on the basis of the placement information stored in the server is treated as a checkpoint, so that the entertainment characteristics of the game can be improved.

### (Configuration 5)

In Configuration 5 based on Configuration 3 above, at a predetermined timing, when no placement object exists in the game stage, the placement object based on the placement information stored in the predetermined server may be placed in the game stage.

According to the above configuration, even if no other player object is present in the same game stage, an opportunity to return from the special state to the normal state can be given to the player, and such opportunities can be increased.

### (Configuration 6)

In Configuration 6 based on Configuration 1 above, the game program may further cause the processor to: determine whether or not the revival assistance object exists within a predetermined range from the player object, when a mistake occurs in the predetermined game stage; and shift the player object to the special state where the player object does not become damaged in the game stage, if it is determined that the revival assistance object exists within the predetermined range from the player object.

According to the above configuration, even when the mistake occurs, if any revival assistance object exists within the predetermined range, the play is not immediately terminated, and the player object is shifted to the special state. Then, if the player object in the special state comes into contact with the revival assistance object, the player object can be revived to the normal state. Therefore, if any other player object is present nearby in the game stage, even if the mistake is made, the play is not immediately terminated, and an opportunity to continue the play is given to the player. Accordingly, it is possible to provide motivation to play online together with other players in order to obtain such opportunities. In addition, when another player causes an event that can terminate the play, if the distance between the player object and the other player object is outside the predetermined range, an opportunity for the above revival is not obtained, so that the player can continue the game play while maintaining their own pace, without worrying about other players more than necessary.

### (Configuration 7)

In Configuration 7 based on Configuration 6 above, the player object may be operable while being in the special state, a state where the player object is in the special state may continue for a predetermined time, and the play of the game stage may be terminated if the player object has not come into contact with the revival assistance object within the predetermined time after the player object is shifted to the special state.

According to the above configuration, since there is a time limit for remaining in the special state, a sense of tension can be provided to the play, thereby improving the entertainment characteristics of the game.

### (Configuration 8)

In Configuration 8 based on Configuration 7 above, when the shift to the special state occurs in the same game stage a plurality of times, the predetermined time may be gradually shortened as the number of times of the shift to the special state increases.

According to the above configuration, if the player object is repeatedly shifted to the special state, the chance for revival is gradually decreased, so that a sense of tension can be provided to the game play.

### (Configuration 9)

In Configuration 9 based on Configuration 6 above, the game program may further cause the processor to cause a ghost character to appear in the game stage, the ghost character acting on the basis of replay data for replaying a play content of another player, and the revival assistance object may include the ghost character related to the other player in addition to the other player object.

### (Configuration 10)

In Configuration 10 based on Configuration 9 above, the game program may further cause the processor to: record an action content of the player object in a predetermined period as the replay data and transmit the replay data to a predetermined server at a predetermined timing; acquire the replay data transmitted by another player, from the predetermined server at a predetermined timing after the play of the game stage by the player is started; and cause the ghost character to act on the basis of the replay data acquired from the predetermined server.

According to the above configuration, the ghost character can be caused to appear instead of the other player object. Accordingly, even in a situation in which the player continues to play without encountering other players, by causing the ghost character to appear, it is possible to provide an experience of playing as if playing online together with other players.

### (Configuration 11)

In Configuration 11 based on Configuration 6 above, the other player object may not affect the player object in the normal state.

According to the above configuration, since the player character in the normal state receives no interference from the other player character, the own game play is not disturbed by play by another player. Therefore, while the player proceeds through the game stage at their own pace, the player can be helped by another player when an event that can terminate the play occurs. Accordingly, it is possible to provide the benefits of playing online and promote online play.

### (Configuration 12)

In Configuration 12 based on Configuration 11 above, the other player object may be displayed in a semi-transparent manner when the player object is in the normal state, and may be displayed in an opaque manner when the player object is in the special state.

According to the above configuration, when the player object is in the special state, the player is allowed to intuitively grasp that something will happen if the player object comes into contact with the other player object.

### (Configuration 13)

In Configuration 13 based on Configuration 12 above, when the player object is in the special state, a game screen may be displayed such that a saturation of the game stage is decreased except for the revival assistance object.

According to the above configuration, when the player object is in the special state, the revival target can be made visually conspicuous.

### (Configuration 14)

In Configuration 14 based on Configuration 1 above, when the player object is returned to the normal state, the player object in the normal state may be placed at a position where the mistake does not occur immediately after the player object is returned to the normal state.

According to the above configuration, it is possible to inhibit the mistake from occurring at the same time as the player object is returned from the special state to the normal state.

According to the present disclosure, even if a player makes a mistake, play can continue without being terminated if the player can come into contact with a revival assistance object including a placement object placed in the game stage by another player object and another player object.

### BRIEF DESCRIPTION OF THE DRAWINGS

FIG. 1 is a schematic diagram showing a non-limiting example of the entire configuration of a game system according to an exemplary embodiment;

FIG. 2 is a block diagram showing a non-limiting example of the hardware configuration of a game server 1;

FIG. 3 is a block diagram showing a non-limiting example of the hardware configuration of a game apparatus 3;

FIG. 4 shows a non-limiting example of a game screen;

FIG. 5 shows a non-limiting example of the game screen;

FIG. 6 shows a non-limiting example of the game screen;

FIG. 7 shows a non-limiting example of the game screen;

FIG. 8 shows a non-limiting example of the game screen;

FIG. 9 shows a non-limiting example of the game screen;

FIG. 10 shows a non-limiting example of the game screen;

FIG. 11 shows a non-limiting example of the game screen;

FIG. 12 is a non-limiting example diagram for describing transition of a state;

FIG. 13 is a non-limiting example diagram for describing a revival position;

FIG. 14 is a non-limiting example diagram for describing the revival position;

FIG. 15 is a non-limiting example diagram for describing the revival position;

FIG. 16 is a non-limiting example diagram for describing the revival position;

FIG. 17 is a non-limiting example diagram for describing the revival position;

FIG. 18 is a non-limiting example diagram for describing the revival position;

FIG. 19 is a non-limiting example diagram for describing the revival position;

FIG. 20 is a non-limiting example diagram for describing the revival position;

FIG. 21 is a non-limiting example diagram for describing the revival position;

FIG. 22 shows a non-limiting example of an effect of changing to a special state;

FIG. 23 is a non-limiting example diagram for describing a panel;

FIG. 24 is a non-limiting example diagram for describing the panel;

FIG. 25 is a non-limiting example diagram for describing the panel;

FIG. 26 is a non-limiting example diagram for describing the panel;

FIG. 27 illustrates a memory map showing a non-limiting example of various kinds of data stored in a storage section 12 of the game server 1;

FIG. 28 shows a non-limiting example of the data structure of stage room management data 304;

FIG. 29 shows a non-limiting example of the data structure of replay management data 305;

FIG. 30 shows a non-limiting example of the data structure of panel management data 306;

FIG. 31 illustrates a memory map showing a non-limiting example of various kinds of data stored in a storage section 32 of the game apparatus 3;

FIG. 32 shows a non-limiting example of the data structure of remote character data 361;

FIG. 33 shows a non-limiting example of the data structure of player actor management data 363;

FIG. 34 shows a non-limiting example of the data structure of panel data 364;

FIG. 35 is a non-limiting example flowchart showing the details of game processing executed in the game apparatus 3;

FIG. 36 is a non-limiting example flowchart showing the details of the game processing executed in the game apparatus 3;

FIG. 37 is a non-limiting example flowchart showing the details of a stage preparation process;

FIG. 38 is a non-limiting example flowchart showing the details of a room entry/exit check process;

FIG. 39 is a non-limiting example flowchart showing the details of the room entry/exit check process;

FIG. 40 is a non-limiting example flowchart showing the details of a remote panel check process;

FIG. 41 is a non-limiting example flowchart showing the details of a normal state process;

FIG. 42 is a non-limiting example flowchart showing the details of the normal state process;

FIG. 43 is a non-limiting example flowchart showing the details of an own panel placement process;

FIG. 44 is a non-limiting example flowchart showing the details of a special state process;

FIG. 45 is a non-limiting example flowchart showing the details of a replay ghost process;

FIG. 46 is a non-limiting example flowchart showing the details of a stage clearing process;

FIG. 47 is a non-limiting example flowchart showing the details of a restart process, and

FIG. 48 is a non-limiting example flowchart showing the details of game server processing executed in the game server 1.

### DETAILED DESCRIPTION OF NON-LIMITING EXAMPLE EMBODIMENTS

Hereinafter, one exemplary embodiment of the present disclosure will be described. FIG. 1 is a schematic diagram showing the entire configuration of an information processing system (game system) according to the exemplary embodiment. An information processing system 100 of the exemplary embodiment includes a game server 1 and a plurality of information processing terminals 3. The game server 1 and each information processing terminal 3 are configured to be able to communicate with each other via a network 10 such as the Internet. In the exemplary embodiment, with such a configuration, information processing is executed. Hereinafter, a description will be given with game processing as an example of the information processing. Specifically, it is assumed as an example that a game program is installed on the information processing terminal 3 and the game processing is executed while the information processing terminal 3 is communicating with the game server 1 as necessary.

### [Hardware Configuration of Game Server]

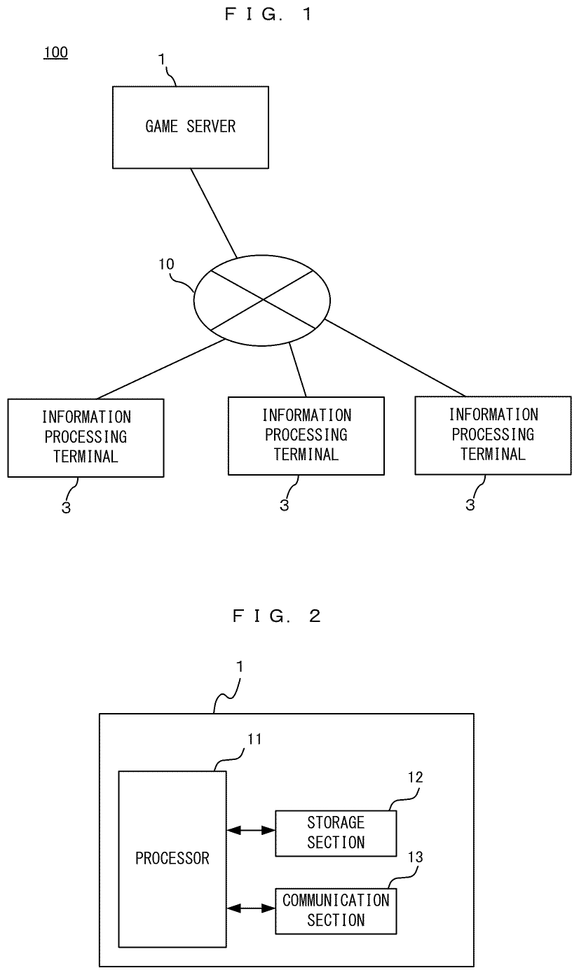

Next, the hardware configuration of the game server 1 will be described. FIG. 2 is a block diagram illustrating the hardware configuration of the game server 1. The game server 1 includes at least a processor 11, a storage section 12, and a communication section 13. The processor 11 executes various programs for controlling each server. In the storage section 12, various programs to be executed by the processor 11 and various kinds of data to be used by the processor 11 are stored. The communication section 13 connects to a network by means of wired or wireless communication and transmits/receives predetermined data to/from each information processing terminal 3 or another server. In the exemplary embodiment, an example in which there is one game server 1 is illustrated, but a group of servers that perform distributed processing may be configured.

### [Hardware Configuration of Game Apparatus]

Next, the information processing terminal 3 will be described. The information processing terminal 3 is, for example, a smartphone, a stationary or hand-held game apparatus, a tablet terminal, a mobile phone, a personal computer, a wearable terminal, or the like. In the exemplary embodiment, a stationary game apparatus (hereinafter, referred to simply as game apparatus) will be described as an example of the information processing terminal 3.

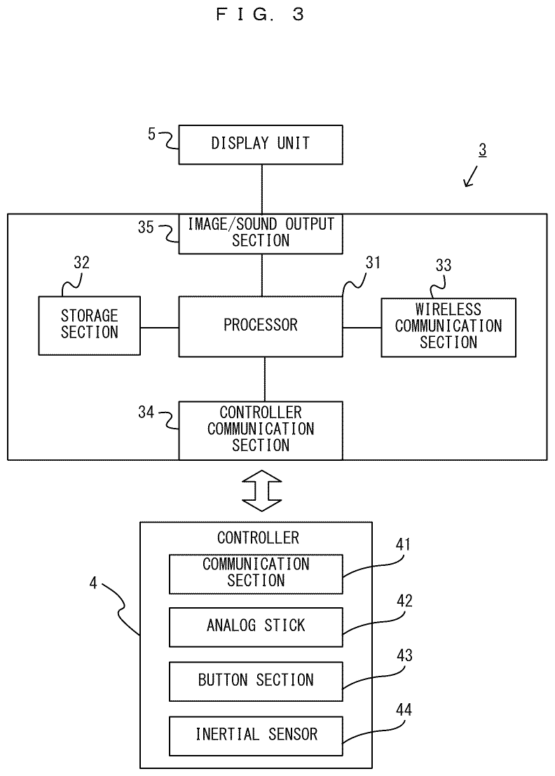

FIG. 3 is a block diagram showing an example of the hardware configuration of a game apparatus 3 according to the exemplary embodiment. In FIG. 3, the game apparatus 3 includes a processor 31. The processor 31 is an information processing section for executing various types of information processing to be executed by the game apparatus 3. For example, the processor 31 may be composed only of a CPU (Central Processing Unit), or may be composed of a SoC (System-on-a-chip) having a plurality of functions such as a CPU function and a GPU (Graphics Processing Unit) function. The processor 31 performs the various types of information processing by executing an information processing program (e.g., a game program) stored in a storage section 32. The storage section 32 may be, for example, an internal storage medium such as a flash memory and a dynamic random access memory (DRAM), or may be configured to utilize an external storage medium mounted to a slot that is not shown, or the like.

The game apparatus 3 also includes a wireless communication section 33 for the game apparatus 3 to perform wireless communication with another game apparatus 3 or the above server. As this wireless communication, for example, internet communication or short-range wireless communication is used.

The game apparatus 3 also includes a controller communication section 34 for the game apparatus 3 to perform wired or wireless communication with a controller 4.

Moreover, a display unit 5 (for example, a television or the like) is connected to the game apparatus 3 via an image/sound output section 35. The processor 31 outputs an image and sound generated (for example, by executing the above information processing) to the display unit 5 via the image/sound output section 35.

Next, the controller 4 will be described. The controller 4 includes at least one analog stick 42 which is an example of a direction input device. The analog stick 42 can be used as a direction input section with which a direction can be inputted. By tilting the analog stick 42, a user is allowed to input a direction corresponding to the tilt direction (also input a magnitude corresponding to the tilt angle). In addition, the controller 4 includes a button section 43 including various operation buttons. For example, the controller 4 may include a plurality of operation buttons on a main surface of the housing.

Moreover, the controller 4 includes an inertial sensor 44. Specifically, the controller 4 includes an acceleration sensor and an angular velocity sensor as the inertial sensor 44. In the exemplary embodiment, the acceleration sensor detects the magnitudes of accelerations along predetermined three axial directions. In addition, the angular velocity sensor detects angular velocities about predetermined three axes.

The controller 4 also includes a communication section 41 for performing wired or wireless communication with the controller communication section 34. The content of a direction input to the analog stick 42, information indicating the press state of the button section 43, and various detection results by the inertial sensor 44 are repeatedly outputted to the communication section 41 and transmitted to the game apparatus 3 at appropriate timings.

### [Outline of Information Processing in Exemplary Embodiment]

Next, an outline of information processing according to the exemplary embodiment will be described. In the exemplary embodiment, a description will be given assuming processing of a game played by a player operating a player character object (hereinafter referred to as player character) that exists in a virtual space, as an example of the information processing. More specifically, in the exemplary embodiment, a description will be given assuming a side-scrolling type action game (hereinafter referred to as “this game”). In this game, a two-dimensional virtual space called a “stage” which is a main stage of play is prepared. For the stage, a start point and a goal point are set. Various enemy characters and obstacles and various gimmicks such as jump stands and pitfalls are placed between the start point and the goal point. This game is a game in which the player character is caused to reach the goal point while defeating or avoiding these enemy characters, etc. The stage is sometimes called a “course”, a “round”, etc., depending on the game. In the exemplary embodiment, a game in which a game screen is displayed as a 2D screen is illustrated. However, in another exemplary embodiment, this game may be a game in which the above virtual space is a three-dimensional virtual space and which is displayed on a 3D screen in a first-person view, a third-person view, or the like.

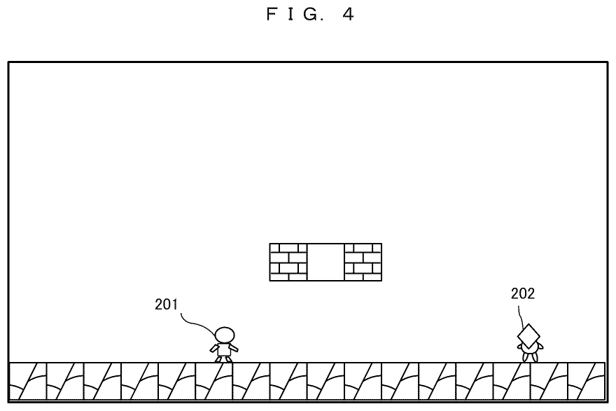

FIG. 4 shows an example of a game screen (hereinafter referred to as “stage screen”) while the stage is being played. The example in FIG. 4 is an example of a screen near the start point, that is, a screen immediately after the start of play of the stage. In FIG. 4, a player character 201 and an enemy character 202 are displayed. In addition, various terrain objects such as blocks are also displayed. In this stage, the start point is set near the left end of the stage, and the goal point is set near the right end of the stage. Therefore, as overall game progress, the stage is configured such that the player character 201 advances toward the right direction of the screen. In such a stage screen, the player operates the player character 201 to move the player character 201 toward the goal point. As the player character 201 moves, another location in the stage is displayed as a stage screen. When the player character 201 reaches the goal point, the stage is cleared.

In the above stage, an “intermediate point” is set at a position roughly halfway between the start point and the goal point. At the intermediate point, an intermediate point object indicating that the position thereof is the intermediate point is placed. When the player character 201 comes into contact with the intermediate point object, if restart is made after that in the play before the goal is reached, restart is made from the intermediate point. Before the intermediate point is reached, restart is made from the start point. The position to be set as the intermediate point is not limited to the position roughly halfway between the start point and the goal point, and a predetermined position may be set as the intermediate point as long as this position is between the start point and the goal point.

### [Online Play Element]

The flow of the basic game progress of this game is as described above, and the game can basically be played as if it were a single-player game. Furthermore, this game can also be played in a multiplayer mode. As an example, this game also has an online play element that allows the game to be played with other players when a connection to the above server or other game apparatuses 3 is made via the internet.

Hereinafter, the online play element of this game will be described. First, the overall network configuration will be described. The basic network configuration is as shown in FIG. 1 above. This game provides a game that uses a communication group structure in a so-called MO (Multiplayer Online) type online game. Specifically, a communication group corresponding to each stage (hereinafter referred to as stage room) can be created and managed as appropriate. In other words, a virtual space corresponding to each stage is prepared, and a predetermined number of players matched by the game server 1 connect to the virtual space. In addition, multiple stage rooms can exist in parallel for the same stage.

In addition, for each stage room, a maximum number of players that can enter the stage room is provided. As an example, in this game, it is assumed that up to four players can enter one stage room. Also, as an example, in this game, game apparatuses 3 in the same stage room are connected by a P2P (Peer to peer) communication method. In another exemplary embodiment, a communication method via a server may be used.

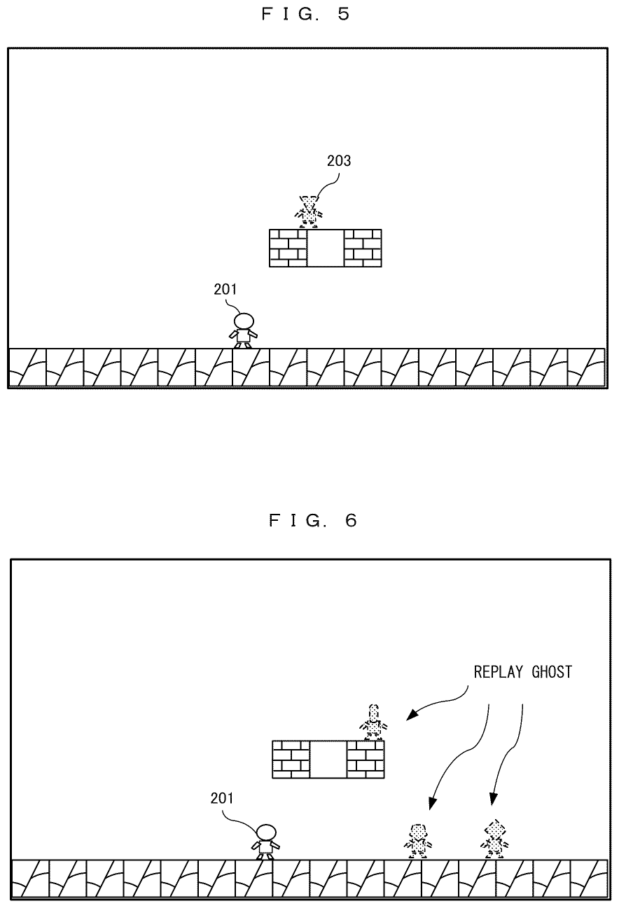

FIG. 5 shows an example of a stage screen outputted from the game apparatus 3 of a player when the player enters a stage room that another player has already entered. In FIG. 5, another player character 203 operated by the other player is displayed on the stage screen in the game apparatus 3 operated by the player. Since the other player has entered the room and has started stage play earlier than the player, the other player character 203 is at a position slightly further ahead toward the goal point than the start point. In FIG. 5, the other player character 203 is displayed in a semi-transparent manner (shown by a dotted line in the drawing).

In this game, multiple types of characters that can be used as player characters are prepared. For example, each player can select one of 12 types of different characters as a player character to be used by the player. Therefore, as the other player character 203, a character selected by the other player and different from the player character 201 can be displayed.

Here, in the following description, another player who enters the same stage room is referred to as “remote player”, and the other player character 203 operated by the remote player is referred to as “remote character”. In addition, although described in detail later, a “replay ghost” can also appear on the stage screen as a player character related to the remote player. In the following, player characters, remote characters, and replay ghosts are sometimes also referred to collectively as “player actor”. In this game, since up to four players can enter one room, up to four player actors can exist in one room at the same time.

### [Remote Characters]

Next, the remote characters will be described in more detail. In this game, a remote character displayed in a stage room move in response to an operation by another player, but does not directly interfere with and affect game play executed on the game apparatus 3 of the player. Specifically, game apparatuses 3 connected to a certain stage room basically share the position information of the player character of each player and the position information of a predetermined object generated by each player character. An example of the predetermined object generated by the player character is a “panel” described later. On the other hand, the states, position information, etc., of other objects such as enemy characters are not shared. For example, in each game apparatus 3, a collision determination process with stage objects, etc., in stage play is performed only for the player character 201 in each game apparatus, and in principle, no collision determination process is performed for the remote characters. Therefore, even if the player character 201 overlaps with the position of a remote character, it will result in the player character 201 moving through the remote character without colliding with the remote character (however, collision determination is exceptionally performed for special characters described later). Also, if a remote character overlaps with an enemy character, no collision determination or the like is performed between the remote character and the enemy character, resulting in the enemy character moving through the remote character. Also, for example, when the player character 201 defeats an enemy character A, the state of the enemy character A is not reflected in another game apparatus 3. In the other game apparatus 3, if the other player of this other game apparatus 3 has not defeated the enemy character A, the enemy character A is controlled in a state where the enemy character A still exists. That is, the progress of stage play itself is managed individually on the game apparatus 3 of each player, and is controlled such that, if there is a remote character in this case, only display of the remote character is performed. In addition, the remote character is basically displayed in a semi-transparent manner in order to make it easy to understand that the remote character is a non-interfering character. Therefore, each player can basically play the stage as if it were a single-player game, without being affected by the actions of the other players and without interfering with the actions of the other players. In other words, each player can obtain a play feeling and a game experience that the player can be aware of the presence of remote characters, in other words, other players while advancing the game alone.

As described above, each player can individually advance the game without being affected by the other players. Therefore, the game is not a game in which stage play cannot be started unless all four players are present, and stage play can be started even when there is only one player in the stage room. After that, other players can enter the room in the middle of the game until the number of players in the room reaches four which is the maximum number. For example, if a player B enters the room when a player A has advanced to about one-third of the stage, the player character of the player B starts moving from the start point. That is, the player B starts stage play in a state where the player character of the player A is present at a somewhat advanced position. The player A can continue to play without the own play being disturbed by the entry of the player B.

### [Replay Ghosts]

Next, the above replay ghosts will be described. Each replay ghost is reproduced as a ghost with replay data of another player. In the exemplary embodiment, play from the intermediate point to the goal point is stored as replay data in the above game server 1. When the play of the game stage has reached a certain degree of progress, the replay ghost is caused to appear. More specifically, if a player has advanced to the intermediate point in a state where the player is the only player entering the stage room, that is, if the player has advanced to the intermediate point without being matched with any other player, the replay data is downloaded from the game server 1 and reproduced. Accordingly, another player character based on the replay data can be displayed as a ghost. This is a replay ghost. In addition, since the replay ghost reproduces replay, the replay ghost behaves in the same manner as the above remote character. Accordingly, if no other player has entered the room until the intermediate point is reached, a situation in which the player plays with the ghost of another player can be created. Therefore, depending on the stage, it is possible to inhibit the player from feeling that playing online is less meaningful due to a fact that matching with another player is taking a long time to occur.

Here, the above replay ghosts are basically indistinguishable from the above remote characters in their appearance. For example, FIG. 6 shows an example of a screen on which replay ghosts are displayed. In FIG. 6, three replay ghosts are displayed. Similar to the above remote characters, these replay ghosts are displayed in a semi-transparent manner. In addition, their appearance is not different from that of the remote characters. Since the remote characters are each operated by a live person, it is possible to perform emotion display such as display of face images showing emotions for the remote characters, for example. Therefore, even though each game apparatus 3 individually manages play, the players can communicate with each other to some extent through such operations. Meanwhile, such communication is not possible with the replay ghosts. Therefore, the remote characters and the replay ghosts may be distinguishable from each other. For example, when approaching a remote character, a sign image from which it is recognized that it is a remote character, such as a user name, may be displayed. On the other hand, as for each replay ghost, when approaching the replay ghost, no such sign image may be displayed. Accordingly, the player can recognize whether it is a remote character or a replay ghost, by the presence or absence of such a sign image.

More precisely, in the exemplary embodiment, a replay ghost is caused to appear when the player character 201 comes into contact with the intermediate point object. This is because it is easy for the player to recognize that the replay ghost appears as a result of passing the intermediate point. In this example, the case where passing the intermediate point is used as an example of the degree of progress of play is described. In another exemplary embodiment, for example, the degree of progress that is a trigger for causing the above replay ghost to appear may be determined on the basis of the elapsed time from the start of stage play or the achievement level of an event in the stage.

Hereinafter, the replay ghosts will be described in more detail.

### [Recording of Replay]

First, recording of replay data will be described. In the exemplary embodiment, recording of replay data is started when the player character 201 comes into contact with the above intermediate point object (hereinafter, this is sometimes described as “passing the intermediate point”). The recording is then stopped when the player character 201 reaches the goal point. Thereafter, the replay data is transmitted to the game server 1 in accordance with a stage clearing process.

The reason why contact with the intermediate point object and reaching the goal point are used as the timings for starting and stopping the recording of replay data is that the recording can be started and stopped by the natural behavior of the player character 201. Another reason for this is, for example, that there is no need to additionally place an object dedicated to control the recording of replay data.

Also, if a “mistake event” occurs before the goal is reached after the intermediate point is passed, the recording of replay data is temporarily stopped at that time. The mistake event will be described later, and such a mistake event is, for example, an event where the player character 201 is defeated by an enemy character. In addition, when a mistake event occurs, if predetermined conditions are satisfied, the play is temporarily suspended, the remaining number of player characters 201 is decreased, and restart is made from the intermediate point. In this case, basically, the replay data before the restart is discarded, and recording of replay data is started again from the time of restart. However, in the exemplary embodiment, in this case, at a certain probability, the replay data before the restart is not discarded and is retained, and recording of replay data from the time of restart is not performed. As described above, replay data is transmitted to the game server 1 when the goal is reached, and if restart occurs in the middle of play due to the control described above, the following two types of replay data can be transmitted. The first one is replay data having a content that the goal has been reached, that is, replay data having a content that the stage has been cleared. The second one is replay data having a content that a mistake event has occurred in the middle, that is, replay data in which the stage has not been cleared. Accordingly, the content of replay data can be diversified.

In the exemplary embodiment, a description will be given assuming that only one intermediate point is set, but there may be a stage in which two or more intermediate points are set. In this case, recording is started from the first passed intermediate point. If a mistake event occurs in the middle of the stage, restart is made from the last passed intermediate point. Then, recording of replay data related to the restart is started again from this last passed intermediate point.

### [Download and Reproduction of Replay Data]

Next, download and reproduction of replay data will be described. Replay data is transmitted to the game server 1 as described above, and in the exemplary embodiment, the replay data is managed in association with each of the intermediate point objects (stages) in the game server 1. More specifically, in the game server 1, the most recent 30 replay data are stored for each stage.

At the timing when the player character 201 passes the intermediate point, a request for replay data is transmitted from the game apparatus 3 to the game server 1. The game server 1 transmits the most recent 30 replay data corresponding to the stage, so that the most recent 30 replay data are received by the game apparatus 3. In the game apparatus 3, up to three replay data to be used as replay ghosts (this is due to the example in which the capacity of the stage room is four players) are randomly selected from among the received 30 replay data. In this case, replay data whose transmission source is the same as the player who has transmitted the above request is excluded from the selection targets. That is, the player's own replay data is prevented from being selected.

Then, reproduction of the selected replay data as a replay ghost is started. In this case, if a plurality of replay ghosts are used, the timings when reproduction as these replay ghosts is started are shifted from each other by several seconds. For example, if three replay ghosts are used, the three replay ghosts are not generated and caused to appear at the same time, but, for example, the second replay ghost is caused to appear 5 seconds after the first replay ghost appears, and the third replay ghost is caused to appear 5 seconds after the second replay ghost appears.

When replay data is downloaded and reproduction thereof is started, if a remote character has come into existence, the replay is not reproduced. For example, this case is the case where another player enters the room at substantially the same time as the intermediate point is passed. This is based on the viewpoint that if a remote character has come into existence, communication with the remote character is desired.

When restart is made from the intermediate point due to occurrence of a mistake event, download of replay data is first started again. Therefore, when restart is made, different replay ghosts may appear before and after the restart. However, if a predetermined time or longer has not elapsed from the completion of the last download, the already downloaded data may be used again. As a matter of course, data may be re-downloaded each time regardless of the elapsed time, or conversely, the initially downloaded data may be used regardless of the elapsed time.

### [Number of Replay Ghosts and Synchronization]

Next, management of the number of replay ghosts and synchronization with other game apparatuses 3 will be described. As described above, in this game, the game progress is managed individually on the game apparatus of each player, and the shared information is basically only the position information of the player character of each player. The replay ghosts are not synchronized with the other game apparatuses 3, and are managed locally on the respective game apparatuses 3. Here, it is assumed that in a situation in which replay ghosts have already appeared, another player enters the room. In this case, adjustment is performed such that the number of player actors in the stage is equal to or smaller than four. For example, it is assumed that in a situation where a player A is playing with three replay ghosts, a player B enters the room. In this case, the following processing is performed in the game apparatus 3 of the player A. First, the replay ghost farthest from the current position of the player character 201 is deleted. Accordingly, one player actor frame becomes empty. Next, a remote character related to the player B is generated and caused to appear in the stage. If there is a replay ghost that is the same character as this remote character, this replay ghost is also deleted. Therefore, in this example, two replay ghosts may be deleted for one player who newly enters the room. In this case, the total number of player actors is three.

Meanwhile, in game processing in the game apparatus 3 of the player B, the game progress is managed with the player character 201 of the player A existing as a remote character in the stage without any replay ghost being present.

### [Cooperation Element]

As described above, basically, each player can individually advance the game without being affected by other players. However, this game has a cooperative play element in the following respects. Specifically, in this game, it is possible to affect other players through a “revival assistance” function by which a player who has made a mistake can be helped.

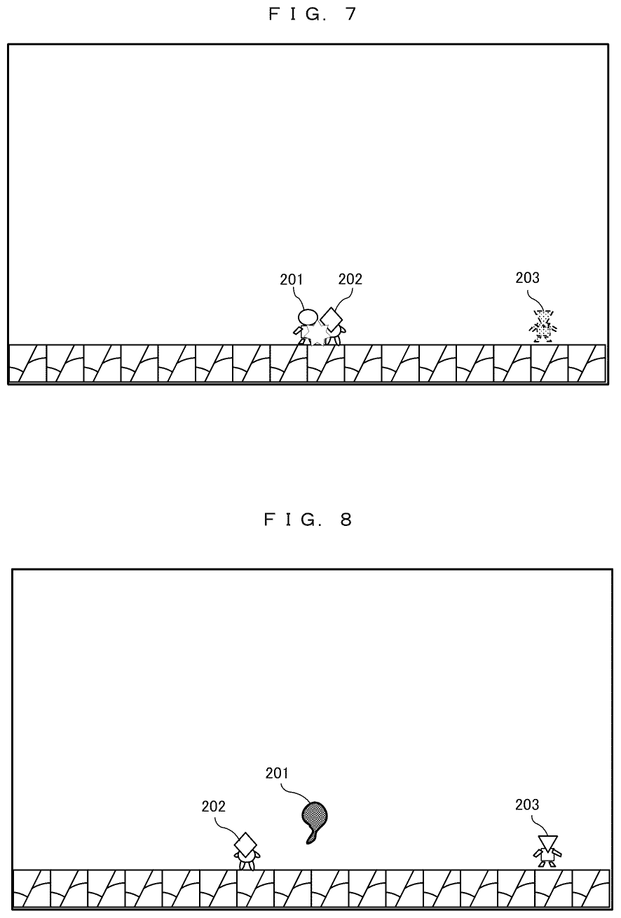

Hereinafter, a specific example of revival assistance will be described. First, it is assumed that a mistake event occurs for the player character 201. In the exemplary embodiment, the mistake event is an in-game event that results in a decrease in the remaining number of player characters (loss of remaining player character). Specifically, for example, as shown in FIG. 7, when the player character 201 comes into contact with the enemy character 202 and it is assumed that single play is performed offline, the mistake event is an in-game event that the play with the currently used player character 201 is temporarily terminated and the remaining number of player characters 201 is decreased by one (hereinafter, this is referred to as “lostness”), and then, after the lostness, restart is made from a predetermined point or game over occurs as it is. Other examples of the mistake event include the case where the HP or life of the player character 201 reaches zero, leading to lostness, the case where the player character 201 goes out of the stage due to falling into a pitfall or the like, etc. For example, if the HP or life is left even after the player character 201 is damaged, lostness does not occur, and thus this case does not correspond to a mistake event (this is treated as mere damage).

In this game, in the case of offline single play, occurrence of the above mistake event directly leads to the lostness as described above, but in the case of playing while connected online, even if a mistake event occurs, lostness does not immediately occur if a predetermined condition is satisfied. In the exemplary embodiment, the predetermined condition is that a “revival assistance object” described later exists within a predetermined range from the player character 201. If the predetermined condition is satisfied, the player character 201 changes into a character object having a different appearance, as shown in FIG. 8, for a predetermined time. Hereinafter, the changed character object is referred to as “special character”. The state of the player character 201 that has changed into the special character is referred to as “special state”, and the state of the player character 201 in which this change has not occurred is referred to as “normal state”. In the special state, the remote character 203 is displayed in an opaque manner rather than in a semi-transparent manner, and this point will be described later.

For the above special character, collision determination with objects other than the revival assistance object is not performed. Therefore, the special character does not receive any damage from enemy characters, etc., and can also move through the enemy character 202 and terrain objects. In addition, while the player character 201 is the special character, the special character can move in the air without being constrained by the gravity in the virtual space. That is, the player can move the special character freely without worrying about collision determination. For example, the player can move the special character straight toward the revival assistance object. However, in the state of the special character, even if the special character reaches the goal point, the special character is not considered to have reached the goal, and the stage cannot be cleared.

In another exemplary embodiment, for the above special character, collision determination with objects other than the revival assistance object may be performed. In addition, as for control of the movement of the special character, movement control affected by the gravity in the virtual space may be performed.

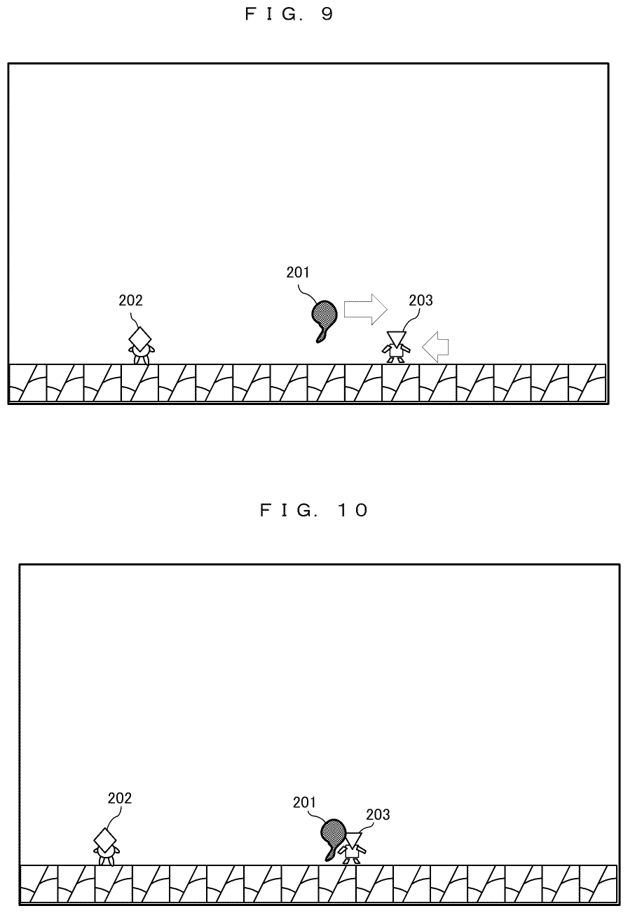

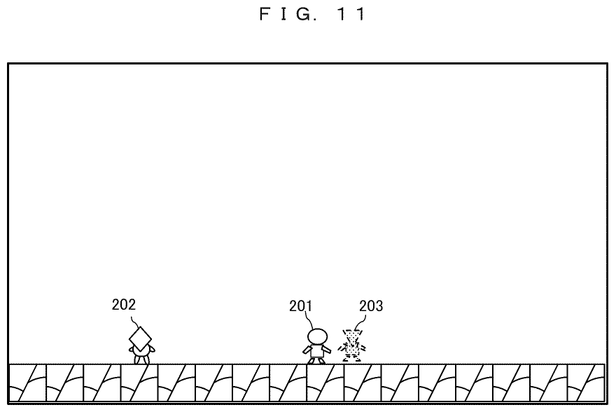

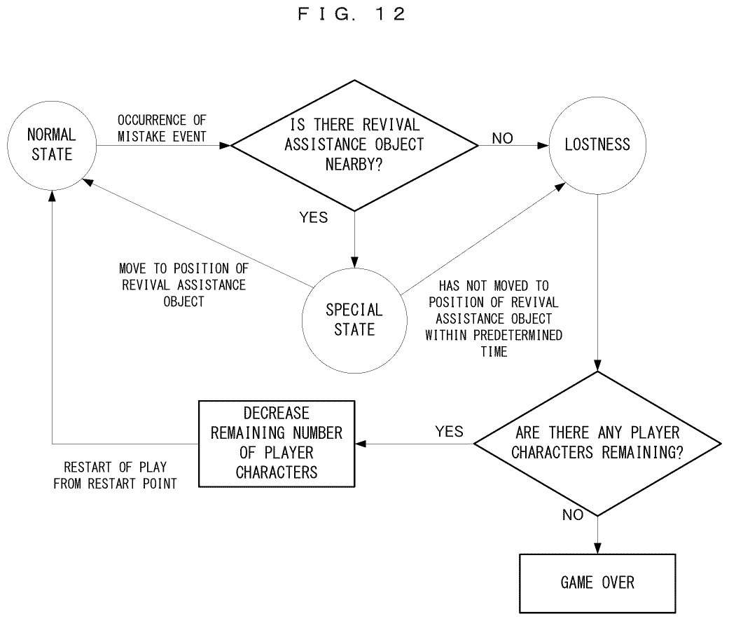

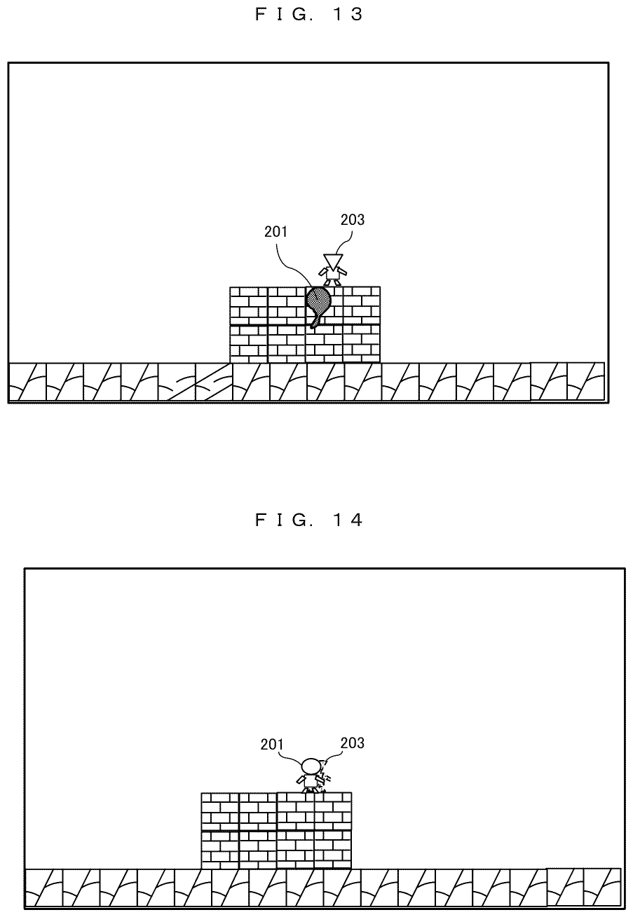

It is assumed that after the player character 201 changes into the special character, the special character is moved toward the above revival assistance object (here, the remote character 203) as shown in FIG. 9. As a result, before the predetermined time has elapsed, the position of the remote character 203 and the position of the special character overlap each other as shown in FIG. 10. That is, the revival assistance object and the special character come into contact with each other. Then, as shown in FIG. 11, the player character 201 can be returned to the normal state without causing lostness of the player character 201. That is, it is possible to “revive” the player character 201 for which a mistake event has occurred, without causing lostness. In the following description, the above predetermined time is referred to as “revivable time”. The revival is not limited to be performed by bringing the special character and the revival assistance object into contact with each other, and the player character 201 may be revived by bringing the special character and the revival assistance object into close proximity or adjacent to each other.

Meanwhile, if no revival assistance object exists within the predetermined range when a mistake event occurs, change to the special state does not occur, the above lostness is fixed, and as a result, restart is made or game over occurs.

In the exemplary embodiment, when the player character has changed into the special character, the game screen is displayed in monochrome except for the revival assistance object. That is, the game screen is displayed such that the saturation of the terrain objects, enemy characters, etc., is decreased.

The above predetermined range is, for example, a distance range that is the same as or shorter than the upper limit of a distance assumed to allow the player character 201 in the special state to reach the position of the revival assistance object when the player character 201 moves for the revivable time. That is, the predetermined range is assumed to be a range, from the position where the mistake event has occurred, which allows revival from the special state to the normal state to be in time within the revivable time.

Therefore, for example, if the player character 201 and the remote character move together to a certain extent, it is easier to recover from occurrence of a mistake event while still playing the game as if it were single play. That is, an advantage that is not obtained in the case of an offline single-player game and that takes advantage of the online environment is obtained. In addition, in the case of single play, the special state is brought about in a situation in which a “mistake event” to “lostness” occur to interrupt the play, and in the case of online, such interruption does not occur, and the play by the player is not disturbed. By having such a cooperative play element, there can be room for the player to cooperate with other players in a certain situation. Accordingly, a situation can be created in which the game is basically advanced as single play, but if a plurality of players enter the stage room through matching, it becomes easier to cooperate with other players.

By providing the above predetermined range, it is possible to suppress occurrence of a situation in which, when the player character 201 comes into the special state, the player character 201 moves for a large distance to seek help from a remote character or the like that is far away from the player character 201. For example, if the player character 201 returns to the vicinity of the start point where a remote character is present, even though the player character 201 has advanced through the stage to some extent, the tempo at which the game proceeds becomes slow. On the other hand, if it is made possible to move to the position of a remote character that has advanced ahead of the player character 201, while skipping various gimmicks in the middle of the stage, the entertainment characteristics of the game are lost. In order to prevent such a situation, the player character 201 is shifted to the special state only when a revival assistance object exists within the predetermined range as described above.

FIG. 12 shows a diagram summarizing the relationship of state transition of the normal state, the special state, and the lostness described above. In FIG. 12, first, when a mistake event occurs in the normal state, it is determined whether or not there is a revival assistance object within the predetermined range. Then, if there is a revival assistance object, change to the special state occurs. In the special state, if the player character 201 can move to the position of the revival assistance object, the player character 201 can be revived to the normal state. On the other hand, if there is no revival assistance object within the predetermined range, lostness occurs. In this case, if there are player characters 201 that are left, the remaining number is decreased by one, the player character 201 comes into the normal state, and restart is made from a predetermined restart point. If there are no remaining player characters 201 left, game over occurs, and the player is caused to exit the stage room.

In the exemplary embodiment, the above revivable time can vary depending on the number of times of change to the special state. Specifically, the revivable time becomes shorter stepwise as the number of times of change to the special state is increased in one play (e.g., from the start of play until one player character 201 is lost). For example, it is assumed that 10 counts are used as the revivable time. When change to the special state occurs for the first time, the 10 counts are made at 2-second intervals (revivable time=20 seconds). Then, when the player character 201 is revived and changes to the special state again, the 10 counts are made at 1.5-second intervals (revivable time=15 seconds). Furthermore, when the player character 201 changes to the special state for the third time, the 10 counts are made at 1-second intervals (revivable time=10 seconds), and when the player character 201 changes to the special state for the fourth time, the 10 counts are made at 0.5-second intervals (revivable time=5 seconds). Then, if the interval at which the 10 counts are made becomes shorter to some extent, the interval is not shortened any further. For example, the 0.5-second interval is set as a lower limit. Accordingly, if the player causes a mistake event to occur repeatedly, it is gradually made more difficult to revive the player character 201, so that a certain degree of tension can be provided to game play.

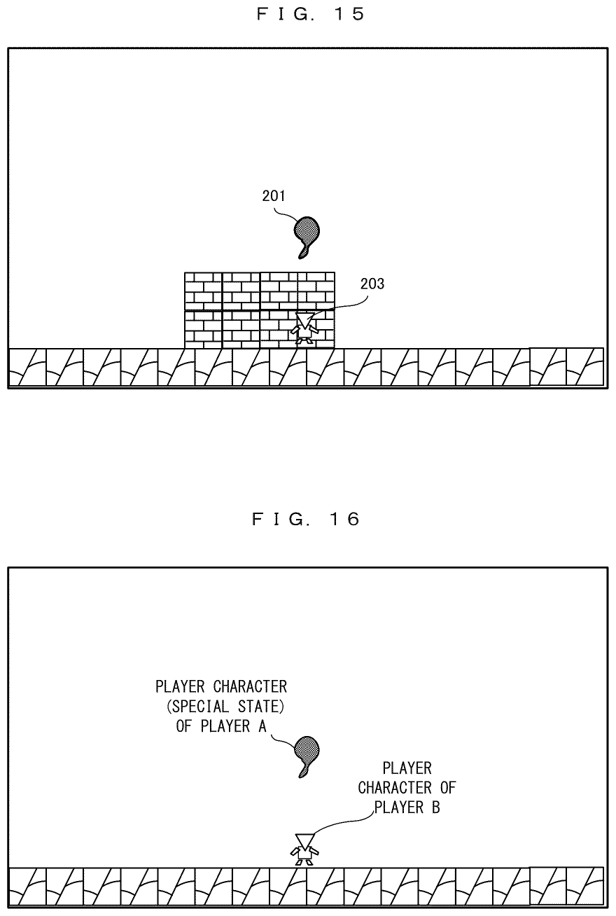

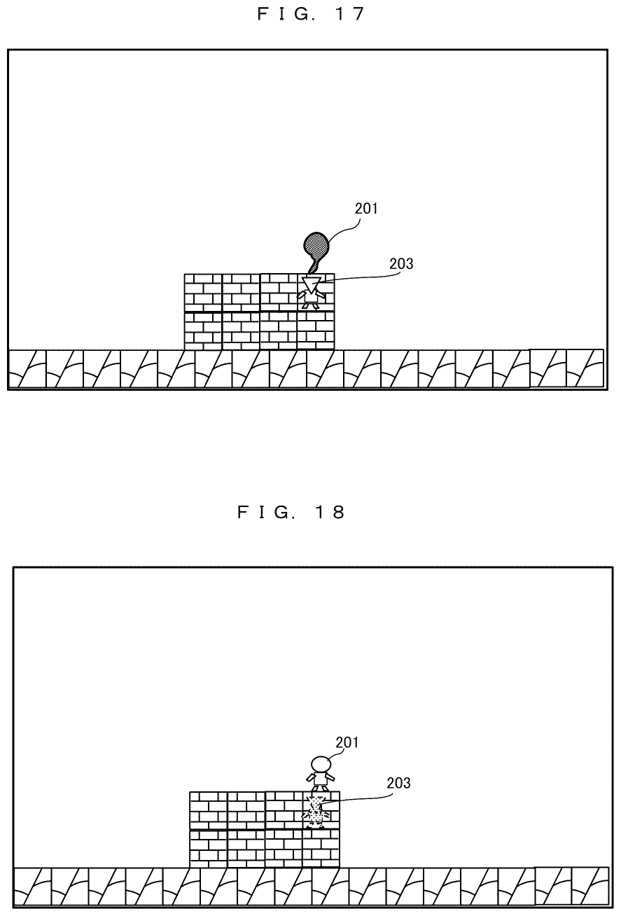

Here, supplementary description will be given regarding a revival position upon revival by the above revival function. Here, processing in the game apparatus 3 in which the special state is brought about is considered as a basis. That is, the game screen in which the special character is operated is considered as a basis. First, it is assumed that the special character and the revival target are both outside the terrain. In this case, if the positions of both overlap each other, the player character 201 is revived at the overlapping position. Next, it is assumed that the special character is located within the terrain as shown in FIG. 13, and the revival target, the remote character 203 in FIG. 13, is outside the terrain. As described above, since no collision determination with terrain objects, etc., is performed while the player character 201 is the special character, such a situation can also occur. In this case, as shown in FIG. 14, the player character 201 is revived at the position at which the remote character is present.

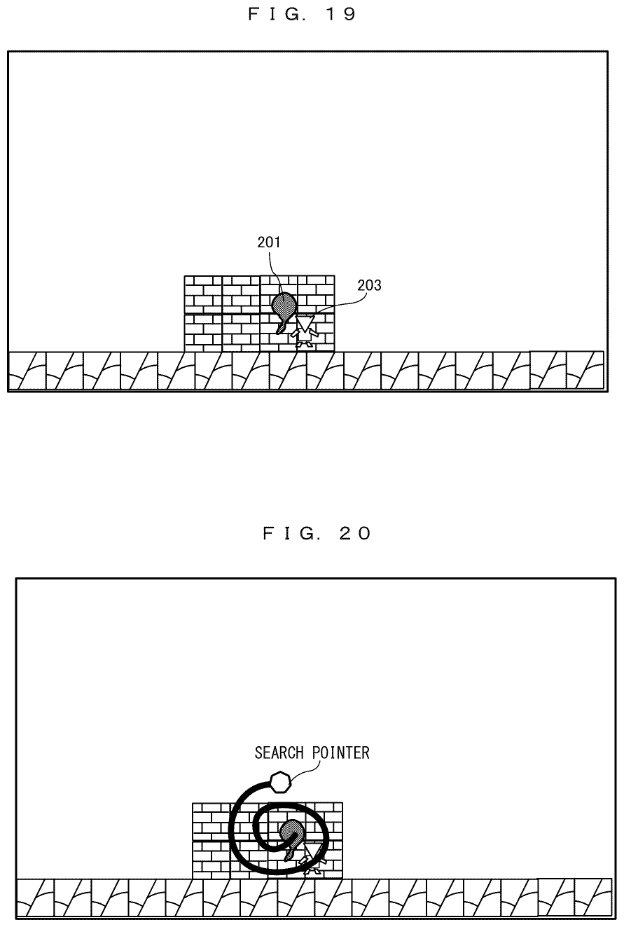

Next, it is assumed that as shown in FIG. 15, the special character is outside the terrain and the revival target (remote character 203) is within the terrain. This can occur in the following case. As described above, in this game, the game progress management itself is performed by the game apparatus of each player. For example, if there is a destructible terrain object, there can be a situation in which, for example, the terrain object has not yet been destroyed in game play by a player Abut has been destroyed in game play by a player B. For example, it is assumed that the player of the special character in FIG. 15 is the player A, and the player of the remote character 203 is the player B. In this case, a game screen corresponding to the situation in FIG. 15 above and viewed by the player B is a game screen shown in FIG. 16. In the game screen of the player B, the terrain object has already been destroyed and the player character 201 of the player B is at a site that has been the site of the terrain object. As described above, the remote characters only share position information, and collision determination with the terrain is not performed in the game apparatus 3 of the player A. Therefore, a screen viewed by the player A can be a screen shown in FIG. 15 above. Then, it is assumed that the player B jumps the remote character toward the special character in this state. As a result, the remote character and the special character are in contact with each other as shown in FIG. 17. In this case, the player character 201 is revived at that spot as shown in FIG. 18.

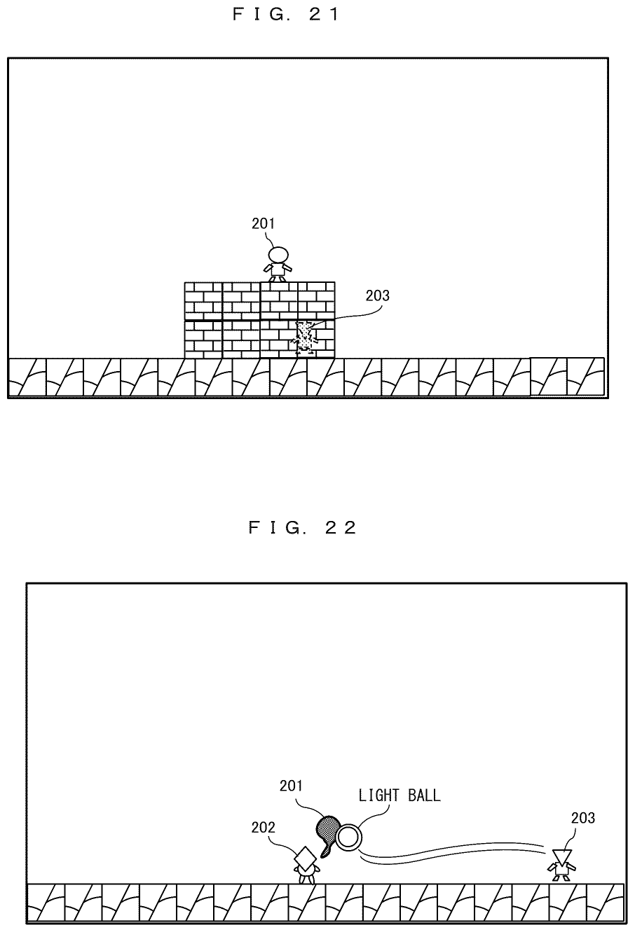

Next, it is assumed that in the screen of the player of the special character, the special character and the revival target object are both located within the terrain as shown in FIG. 19. Then, the positions of both overlap each other within the terrain. In this case, a search is made for a point where the player character 201 can be revived (a point outside the terrain). For example, as shown in FIG. 20, a search is made for a point outside the terrain while an invisible search pointer is moved in a spiral manner away from the special character. Then, the player character 201 is revived at the initially found position outside the terrain. As a result, the player character 201 is revived at a position shown in FIG. 21.

In the case of a situation in which, at the above revival position, there is an object such as an enemy character that can cause a mistake event to occur if the object collides with the player character in the normal state, control may be performed such that the revival position is further shifted to a position where collision with the enemy character does not occur. That is, finally, a position where there are no obstacles such as terrain objects and enemy characters may be determined as the revival position.

### [Revival Assistance Object]

Next, the above revival assistance object will be described. In the exemplary embodiment, as the revival assistance object, there are the following three types of objects.
(1) Remote character
(2) Replay ghost
(3) Panel

The panel is further classified into two types: “remote panel” and “server panel”. Each type will be described below.

### [Revival Assistance Object: Remote Character]

First, the remote character is as described above, and thus the detailed description thereof is omitted, but supplementary description will be given regarding a display form thereof. As described above, the remote character is basically displayed in a semi-transparent manner. However, when the player character 201 has changed into the special character, the special character is displayed in an opaque manner rather than in a semi-transparent manner. In addition, while the remote character is displayed in an opaque manner, collision determination between the remote character and the special character is performed. In other words, while the player character 201 is in the special state, the remote character is made to appear as if it were substantialized. At this time, the remote character is also in a state where the remote character can directly affect the player character 201 so as to revive the player character 201 as described above. In addition, as described above, in the exemplary embodiment, when the player character 201 has changed into the special character, the game screen is displayed in monochrome except for the revival assistance object. Therefore, the colored remote character is displayed in an opaque manner in the monochrome image, making the remote character more conspicuous. This can remind the player that something will happen or the player character 201 can be revived if the player character 201 comes into contact with the remote character, and can visually show the player where to go in an easy-to-understand manner.

When the above mistake event occurs and the player character 201 changes into the special character, a light ball may be sent from the closest revival assistance object to the player character 201 as shown in FIG. 22. Then, the player character 201 that receives the light ball may then be shown to change into the special character. This can remind the player that the player character 201 may be saved if coming into contact with the revival assistance object that has sent the light ball. In other words, the player can be made aware of the cause-and-effect relationship between the revival assistance object and change into the special character.

### [Revival Assistance Object: Replay Ghost]

The above replay ghost also functions as a revival assistance object. This is because, as described above, the replay ghost behaves in the same manner as the remote character. Therefore, the replay ghost as a revival assistance object is controlled in the same manner as the remote character. As a result, when a mistake event occurs, if the remote character or the replay ghost is within the predetermined range from the player character 201, the player character 201 can change into the special character.

### [Panel]

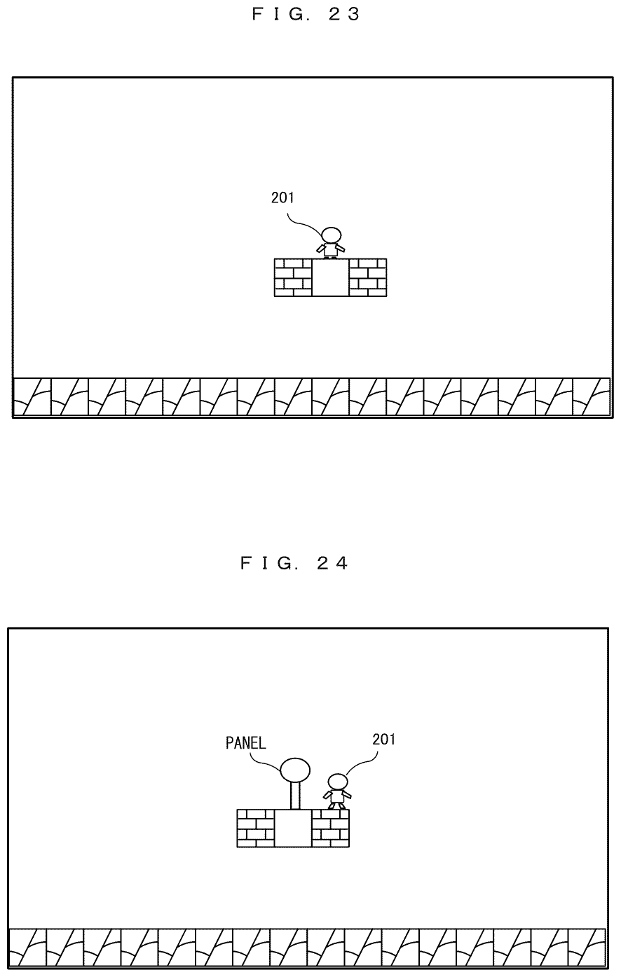

Next, an outline of the above panel will be described. The panel is an object on which the player character 201 can be placed or with which the player character 201 can come into contact. The panel is also an object that has the property of remaining in a stage room after the player exists the stage room. For example, when the player performs a panel placement operation in a game screen shown in FIG. 23, a panel can be placed as shown in FIG. 24. The panel placed by the player is also displayed on the game screens of other players who enter the stage room later. Conversely, panels placed by other players (remote characters) are displayed on the game screen of the player, and the player character 201 can come into contact with the panels. In addition, the panel functions as the above revival assistance object. Therefore, the player character 201 can be revived by coming into contact with the panel within the revivable time when the player character 201 is the special character. However, in the exemplary embodiment, the special character cannot come into contact with the panel placed by the player. That is, panels with which the special character can come into contact are only remote panels which are the panels placed by the remote characters, and server panels described below. This is because, where each panel functions as the above revival assistance object, there is a possibility that the difficulty of the game is not appropriately balanced, for example, the game becomes excessively easy if the panel placed by the player is treated as a revival assistance object. Therefore, in the exemplary embodiment, the special character cannot come into contact with the panel placed by the player (this panel cannot be used as a revival assistance object).

In the exemplary embodiment, the location where the player character 201 can place a panel is limited to a location where there is a platform, and a panel cannot be placed in the air, for example.

The above panel-like design is an example, and its appearance does not have to look like a panel.

[Number of Panels that can be Placed]

In the exemplary embodiment, it is assumed that up to four panels can be placed in one stage. In addition, it is assumed that only one panel can be placed by one player. Therefore, if a player places a panel and then performs another panel placement operation at a different location, the previously placed panel is deleted and a panel is placed at that different location.

[Synchronization of Panels with Other Game Apparatuses]

As described above, the panel placed by the player is also displayed on the game screens of other players. That is, in the exemplary embodiment, the position of the placed panel is also shared. Specifically, “placement event information” indicating that a “panel is placed” and indicating the placement position (coordinates) of the panel is transmitted from the game apparatus 3 of the player who has placed the panel, to other game apparatuses. In the other game apparatuses 3 that receive this information, a process of placing the panel is performed in local game processing. However, such synchronization is performed only when a panel is placed, and subsequent deletion, etc., of the panel are managed locally by each game apparatus 3. Therefore, for example, when a new panel is placed, the placement of that panel is synchronized, but a situation can occur in which, depending on the subsequent development of game play on each game apparatus, the panel is left in a certain game apparatus, but is deleted in a different game apparatus.

### [Revival Assistance Object: Remote Panel]

Next, among the above panels, the remote panel will be described. As described above, the remote panel is a panel placed by the remote character. When the player character 201 is in the normal state, if the player character 201 comes into contact with the remote panel, the panel shakes in reaction, and the name of the remote player who has placed this panel is displayed. In addition, when the player character 201 is in the special state, if the player character 201 comes into contact with the remote panel within the above revivable time, the player character 201 can be revived as in the case with the remote character. In other words, this means that when the player places the panel, this panel becomes a remote panel when viewed by other players, and the player can indirectly help other players even if the player character 201 of the player is not on the same screen. For example, by placing a panel at a location where the player thinks the above mistake event is likely to occur frequently, the panel can be expected to indirectly help other players.

### [Revival Assistance Object: Server Panel]

Next, the server panel will be described. In the game according to the exemplary embodiment, a large number of various stages are prepared, and the player can select and play a stage to be played from among these stages. However, whereas a large number of stages are prepared, there is a possibility that, depending on the stage, the number of players playing the stage is relatively small, and the above panels are not placed very often. Therefore, in the exemplary embodiment, information regarding a panel placed by each player (hereinafter referred to as panel information set) is stored in the game server 1. The panel information set is then used when a new stage room is created, etc., to create a state where the panel is placed on a stage. A panel placed on the basis of such a panel information set stored in the game server 1 is a server panel. The server panel will be described in detail below.

### [Transmission of Information to Server]

First, the transmission of the panel information set to the game server 1 will be described. In the exemplary embodiment, when a player exits a stage room, a panel information set regarding a panel placed by the player is transmitted to the game server 1. Examples of the exit from the stage room include the case where the goal is reached, the case of retiring, without clearing the stage, due to game over or the like, etc. The panel information set includes at least information indicating the stage in which the panel is placed, and the placement position of the panel. However, when a player exits a stage room, if a panel placed by the player has already been deleted, the panel information set is not transmitted. If the panel information set regarding a panel placed by the player in the stage has been stored in the game server 1, the existing panel information set is deleted, and a new panel information set is registered. This is, for example, to suppress occurrence of a situation in which, for a stage that has not been played very often, a certain player repeatedly “enters the stage room, places a panel, and exits the stage room”, whereby all panels for the stage become panels related to the same player.

### [Reception and Placement of Server Panel]

Next, the use of the panel information set transmitted to the game server 1 as described above will be described. First, when a player enters a stage room, if the number of panels placed in the stage is zero, a panel information set is acquired from the game server 1. Examples of the situation in which the number of panels is zero when the player enters the room are the following situations. First, there is a case where a new stage room is created. Second, there is a case where, when the player enters an existing stage room, no panel is placed in the stage at that time. In other words, a server panel can be placed only in a situation in which there is no panel in the stage when the player enters the room.

Regarding the point of acquiring a panel information set from the game server 1, in the exemplary embodiment, the most recent 30 panel information sets which are associated with the stage are acquired from the game server 1. As described above, if the same player transmits a panel information set a plurality of times for the same stage, only the most recent panel information set is stored in the game server 1. Therefore, the acquired panel information set group does not include a plurality of panel information sets related to the same player. Up to four panel information sets are selected from the panel information set group. In the exemplary embodiment, since the capacity of the stage room is up to four players, the maximum number of panel information sets is set to 4 according to this number of players, but it is needless to say that the number of panel information sets to be selected may be four or more or may be four or less. The method of selection may be, for example, random selection.

Next, server panels are generated on the basis of the selected panel information sets. Then, the server panels are placed at positions indicated by the respective panel information sets. Here, it is conceivable that a panel placed by a player in the past when the player entered a stage may exist as a server panel. In this case, the server panel placed by the player in the past is determined to be a panel of the player, and when the player places a new panel later, this server panel is caused to disappear.

### [Activation of Server Panel]

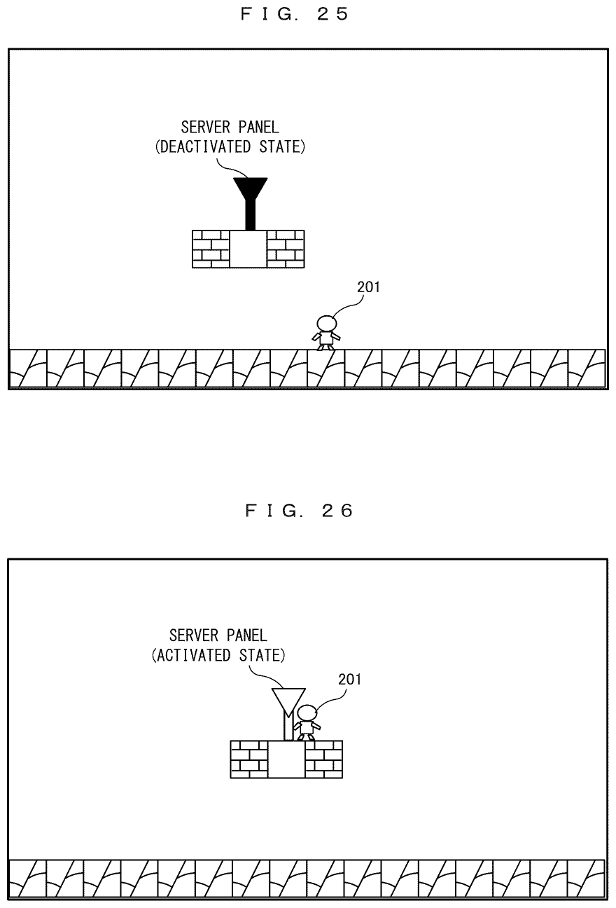

Next, activation of the server panel will be described. The server panel can be placed as described above, and is initially deactivated. That is, when the server panel is placed, the server panel does not function as the revival assistance object described above. FIG. 25 shows an example of the server panel in a deactivated state. As shown in FIG. 25, the server panel in a deactivated state is displayed so as to be filled with black. The display form indicating that the server panel is in a deactivated state is not limited to filling with black, and may be any display form. By the player character 201 coming into contact with the server panel in a deactivated state, the server panel can be activated as shown in FIG. 26. FIG. 26 shows that the black-filled display form is cancelled and the server panel is displayed in the same display form as usual. Thus, only the activated server panel functions as the revival assistance object described above. Therefore, if a mistake event occurs near the server panel in a deactivated state, lostness occurs without changing into the special character as described above.

In addition, once the server panel is activated, even if the player character 201 moves away from the server panel, the server panel remains active thereafter. Also, when restart is made, the server panel that has been activated is not deactivated again and remains active.

The reason why the server panel is initially deactivated and is activated by contact of the player character 201 therewith as described above is due to the following reasons. First, when the player character 201 becomes the special character as described above, collision determination with enemy characters and terrain is not performed. Therefore, if the server panel is activated from the beginning, a situation can occur in which, depending on the relationship with the placement position of the server panel, the player intentionally changes the player character 201 into the special character and moves the player character 201 to a location that has not yet been reached in the normal state (where the server panel is located), while the player character 201 remains as the special character. That is, it is conceivable that the player may be able to take a shortcut to a location that has not been reached. To suppress occurrence of such a situation, the server panel is initially deactivated. This is about a stage room in which no other player is present. For example, for a remote panel placed by a remote character in real time, the above shortcut is permitted in order to make players feel the benefits of online play and the cooperative play-like elements. Therefore, the above remote panels are in an activated state from the time when the remote panels are placed.

In addition, the server panel itself is initially deactivated from the viewpoint of providing the passage of the server panel itself, to be like a checkpoint, as a kind of way of playing.

Next, various kinds of data used in the game apparatus 3 and the game server 1 and processing performed by the game apparatus 3 and the game server 1 will be described in detail.

### [Data Used in Game Server 1]

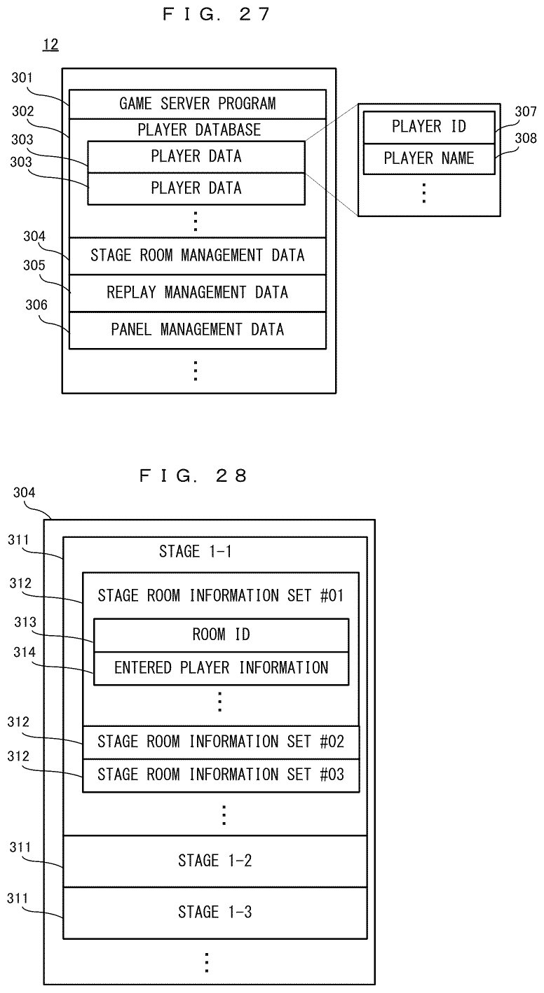

First, data used in the game server 1 will be described. FIG. 27 illustrates a memory map showing an example of various kinds of data stored in the storage section 12 of the game server 1. In the storage section 12 of the game server 1, at least a game server program 301, a player database 302, stage room management data 304, replay management data 305, and panel management data 306 are stored.

The game server program 301 is a program that causes the game server 1 to function in order to realize the game processing described above.

The player database 302 is a database regarding each player who plays the game according to the exemplary embodiment. The player database 302 includes a plurality of player data 303. Each player data 303 includes, for example, a player ID 307 for identifying each player, a player name 308 for each player, etc.

The stage room management data 304 is a database for managing the above stage rooms. FIG. 28 shows an example of the data structure of the stage room management data 304. In FIG. 28, the stage room management data 304 includes a stage room information set 312 for each stage number 311 that identifies each stage. A plurality of stage room information sets 312 can be included for one stage. Each of the stage room information sets 312 is information corresponding to the above stage room. Each stage room information set 312 includes a room ID 313, entered player information 314, etc. The room ID 313 is an ID for uniquely identifying the stage room. The entered player information 314 is information regarding each player who is currently in the stage room. For example, the above player ID 307 is stored in the entered player information 314.

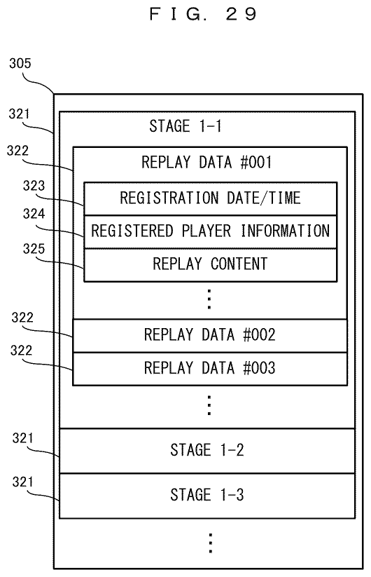

Referring back to FIG. 27, the replay management data 305 is data that is the replay data transmitted from the game apparatus 3 as described above and is stored. FIG. 29 shows an example of the data structure of the replay management data 305. The replay management data 305 includes one or more replay data 322 for each stage number 321. Each replay data 322 includes at least registration date/time 323, registered player information 324, and a replay content 325. The registration date/time 323 indicates the date and time when the replay data was registered in the game server 1. The registered player information 324 is information regarding the player who generated the replay data. The registered player information 324 includes, for example, the above player ID 307, etc. The replay content 325 is data for indicating the content of replay. For example, the replay content 325 is data in which position information of each character related to the replay and information indicating the state of each character are stored in chronological order. The replay content 325 may also be, for example, key data or the like. That is, the replay content 325 may be any data content as long as it is data that allows the operation history of the player to be grasped.

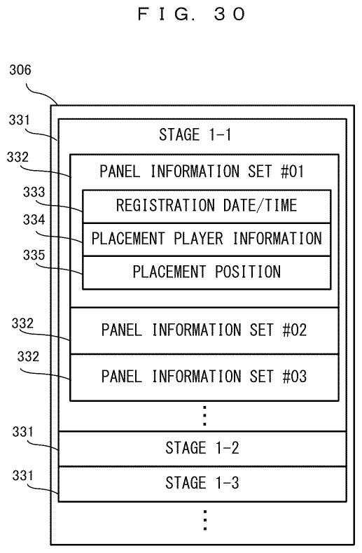

Referring back to FIG. 27, the panel management data 306 is data that is the panel information set transmitted from the game apparatus 3 as described above and is stored. FIG. 30 shows an example of the data structure of the panel management data 306. The panel management data 306 includes one or more panel information sets 332 for each stage number 331. Each panel information set 332 includes at least registration date/time 333, placement player information 334, and a placement position 335. The registration date/time 333 indicates the date and time when the panel information set 332 was registered in the game server 1. The placement player information 334 is information regarding the player who placed a panel related to the panel information set 332. The placement position 335 is information indicating the placement position of the panel related to the panel information set 332.

Although not shown, various kinds of data required to perform a player matching process, etc., can also be stored in the storage section 12.

### [Data Used in Game Apparatus 3]

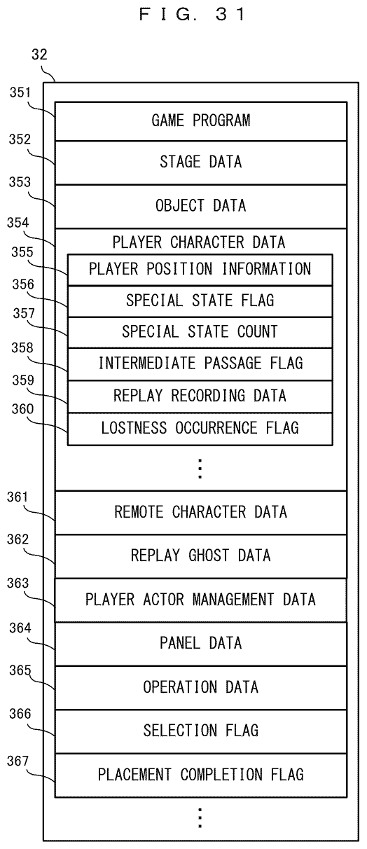

Next, data used in the game apparatus 3 will be described. FIG. 31 illustrates a memory map showing an example of various kinds of data stored in the storage section 32 of the game apparatus 3. In the storage section 32 of the game apparatus 3, at least a game program 351, stage data 352, object data 353, player character data 354, remote character data 361, replay ghost data 362, player actor management data 363, panel data 364, operation data 365, a selection flag 366, and a placement completion flag 367 are stored.

The game program 351 is a program for executing the game processing according to the exemplary embodiment in the game apparatus 3.

The stage data 352 includes data for constructing stages to be played. Specifically, the stage data 352 includes, for each stage, position information of a start point and a goal point, and data indicating various objects to be placed in the stage, such as an intermediate point object.

The object data 353 is master data indicating various objects to be placed in the stage and the appearance of character objects to be displayed as remote characters and replay ghosts. Specifically, the object data 353 includes model data, texture data, etc., for each object.

The player character data 354 is data regarding the player character 201 to be operated by the player. The player character data 354 includes data such as player position information 355, a special state flag 356, a special state count 357, an intermediate passage flag 358, replay recording data 359, and a lostness occurrence flag 360. The player position information 355 is data indicating the position of the player character 201 in the stage to be played. The special state count 357 is a counter for recording the number of times the player character 201 has changed into the above special character. The special state flag 356 is a flag indicating that the player character 201 is in the special state, when being ON, and indicating that the player character 201 is in the normal state, when being OFF. The special state count 357 is counted up by one each time the player character 201 changes into the special character. The special state count 357 is reset when the above lostness occurs. The intermediate passage flag 358 is a flag for indicating whether or not the player character 201 has come into contact with the above intermediate point object. The intermediate passage flag 358 is set to be ON when the player character 201 comes into contact with the intermediate point object. The replay recording data 359 is data for recording data for replay of the player character 201. The lostness occurrence flag 360 is a flag for indicating occurrence of a situation in which the above lostness has occurred. When the lostness occurrence flag 360 is ON, it indicates occurrence of a situation in which the lostness has occurred.

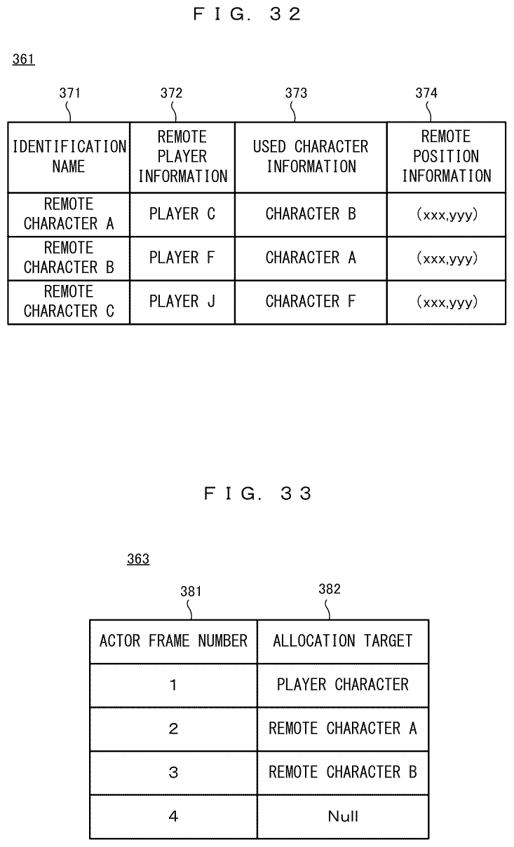

The remote character data 361 is data of a remote character related to each remote player who has entered the same stage room. FIG. 32 shows an example of the data structure of the remote character data 361. In this example, up to four players can enter a stage room. Thus, data for up to three remote characters are stored in the remote character data 361. In addition, each data is generated when a remote player enters the room, and is deleted as appropriate when the remote player exits the room. Each data includes at least an identification name 371, remote player information 372, used character information 373, and remote position information 374. The identification name 371 is an identifier for uniquely identifying each remote character. The remote player information 372 is information for identifying the remote player operating each remote character. The used character information 373 is information that specifies each character to be displayed as a remote character on the screen. That is, the used character information 373 is information indicating each character used as a player character by each remote player. The remote position information 374 is information indicating the position of the remote character in the stage.

Referring back to FIG. 31, the replay ghost data 362 is data regarding each replay ghost described above. Specifically, up to three of the above replay data 322 to be used as the replay ghosts are stored in the replay ghost data 362.

The player actor management data 363 is data for managing the allocation relationship between the player actor frames, the remote characters, and the replay ghosts. FIG. 33 shows an example of the data structure of the player actor management data 363. An actor frame number 381 is a frame number for each player actor. In this example, the case where four player actor frames are prepared is described as an example. An allocation target 382 is information for identifying the player actor allocated to each frame. First, one frame is allocated to the player character 201. Therefore, for each of the remaining three frames, information for identifying either a remote character or a replay ghost is stored. When no remote character or no replay ghost is allocated, Null is set.

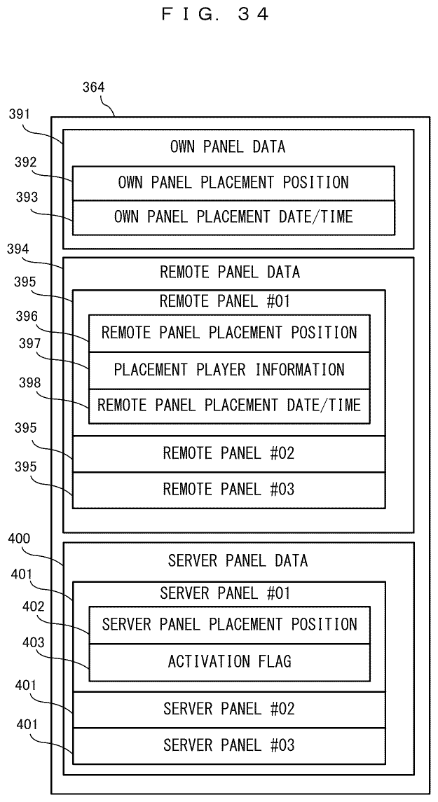

Referring back to FIG. 31, the panel data 364 is data for managing the panels described above. FIG. 34 shows an example of the data structure of the panel data 364. The panel data 364 includes own panel data 391, remote panel data 394, and server panel data 400. In this example, three remote panel data 394 and three server panel data 400 are prepared. The own panel data 391 is information regarding a panel placed by the player character 201 (hereinafter referred to as own panel). The own panel data 391 includes an own panel placement position 392 and own panel placement date/time 393. The own panel placement position 392 indicates the placement position of the own panel, and the own panel placement date/time 393 indicates the date and time when the own panel was placed. When panel placement has been performed a plurality of times, the most recent placement content is stored in the own panel data 391.

The remote panel data 394 is information regarding a panel placed by each remote character. The remote panel data 394 includes a remote panel placement position 396, placement player information 397, and remote panel placement date/time 398. The remote panel placement position 396 indicates the placement position of the remote panel, and the remote panel placement date/time 398 indicates the date and time when the remote panel was placed. The placement player information 397 is information regarding another player who placed the remote panel.

The server panel data 400 is data regarding each server panel described above. The server panel data 400 includes a server panel placement position 402 and an activation flag 403. The server panel placement position 402 indicates the position at which the server panel is placed. The activation flag 403 is a flag indicating whether or not the server panel is activated. The activation flag 403 is initially OFF, and is set to be ON when the server panel is activated.

As shown in FIG. 34, a total of seven panel data for an own panel, remote panels, and server panels can be stored in the panel data 364. However, as described above, only up to four panels can be placed in the stage, and thus data to be actually used are up to four of the data for the seven panels. That is, the content of each data is generated or deleted as appropriate in accordance with occurrence of panel placement such that the number of panels is up to four.

Referring back to FIG. 31, the operation data 365 is data acquired from the controller 4 operated by the player. That is, the operation data 365 is data indicating the contents of operations performed by the player.

The selection flag 366 and the placement completion flag 367 are flags used in a process of placing replay ghosts. The selection flag 366 is a flag for indicating whether or not replay ghosts have been selected from downloaded replay data. The placement completion flag 367 is a flag for indicating whether or not all the selected replay ghosts have been placed in the stage.

In addition, various kinds of data required for game processing which are not shown, such as transmission data for transmitting various kinds of data to other game apparatuses 3, reception data received from other game apparatuses 3, and replay data downloaded from the game server 1, can be generated if necessary and stored in the storage section 32.

Next, the details of the game processing according to the exemplary embodiment will described. First, the details of processing performed in the game apparatus 3 will be described, followed by a description of processing in the game server 1.

### [Details of Processing Performed by Processor 31 of Game Apparatus 3]

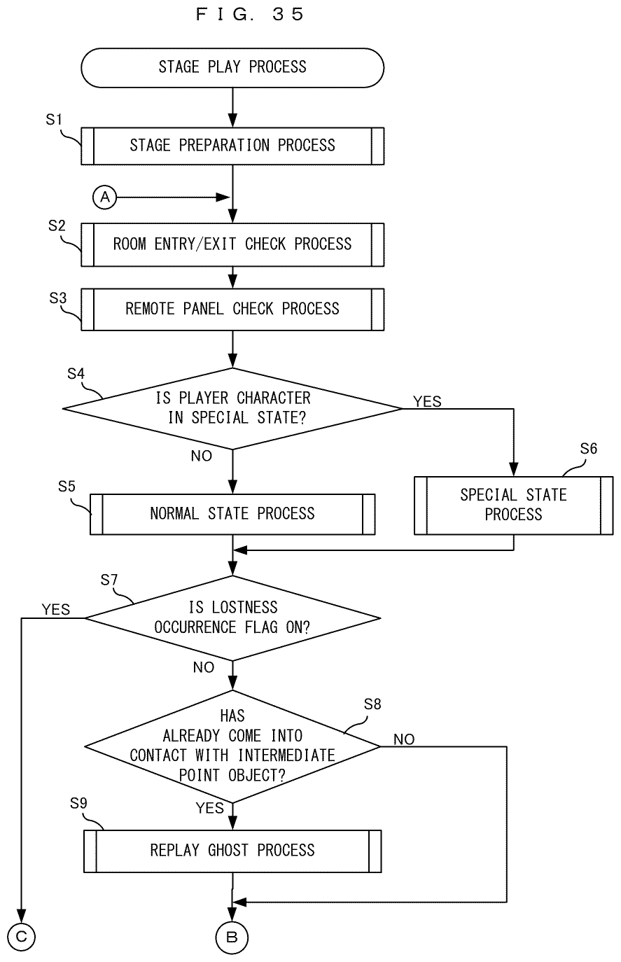

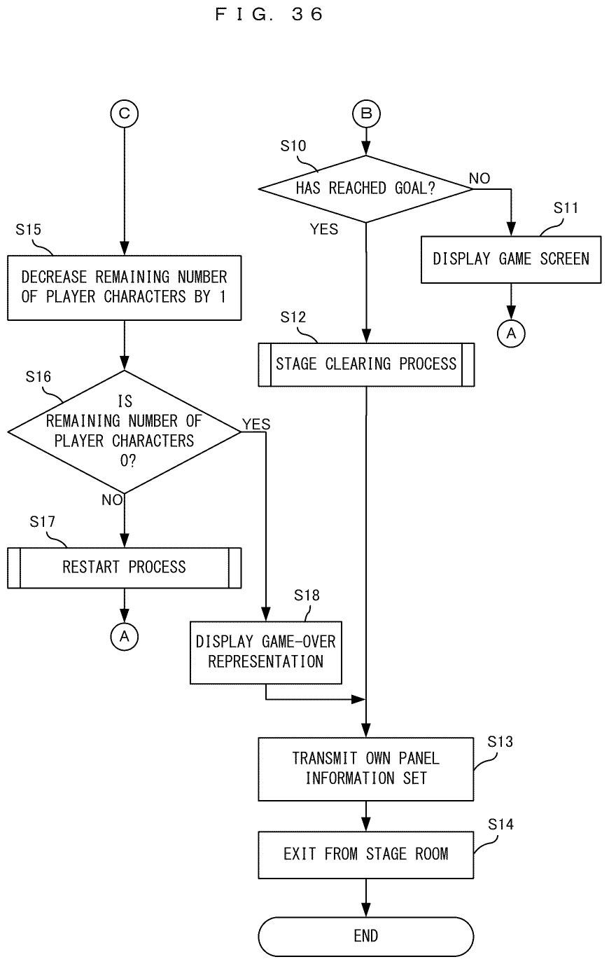

FIG. 35 and FIG. 36 are each a flowchart showing the details of game apparatus-side processing executed by the processor 31 of the game apparatus 3. In the exemplary embodiment, flowcharts described below are realized by one or more processors reading and executing the above program stored in one or more memories. The flowcharts described below are merely an example of the processing. Therefore, the order of each process step may be changed as long as the same result is obtained. In addition, the values of variables and thresholds used in determination steps are also merely examples, and other values may be used as necessary.

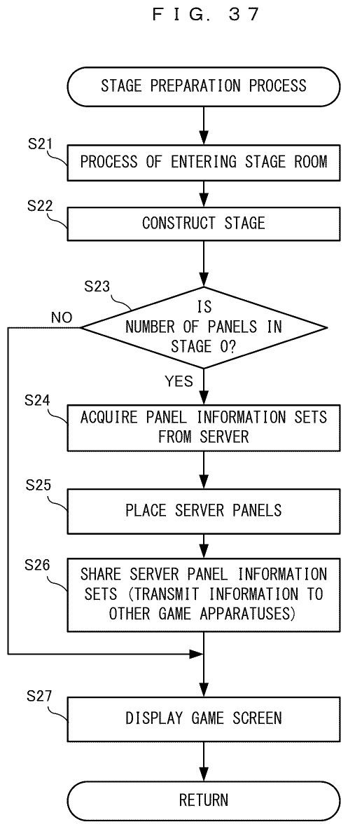

When the player makes an instruction to play a predetermined stage on the game apparatus 3, first, in step S1, the processor 31 executes a stage preparation process. FIG. 37 is a flowchart showing the details of the stage preparation process. In FIG. 37, first, in step S21, the processor 31 performs a process of entering a stage room. Specifically, first, the processor 31 requests a matching process from the game server 1. Then, the processor 31 executes a process of entering a stage room determined on the basis of the matching result. At this time, when entering an existing room, information of a character used as the player character 201 by the player is also transmitted to the game apparatus 3 of each player who has already entered the room.

Next, in step S22, the processor 31 generates the stage (virtual space) to be played this time, on the basis of the stage data 352. Furthermore, when the player enters an existing stage room, the processor 31 receives information of remote characters and remote panels from the other game apparatuses 3. Then, the processor 31 places various characters in the stage.

Next, in step S23, the processor 31 determines whether or not the number of panels in the stage is 0. If, as a result of the determination, the number of panels is not 0 (NO in step S23), the processor 31 advances the processing to step S27 described later. On the other hand, if the number of panels is 0 (YES in step S23), in step S24, the processor 31 acquires the most recent 30 panel information sets from the game server 1. Next, in step S25, the processor 31 randomly selects four panel information sets from among the acquired panel information sets. Then, the processor 31 stores the selected panel information sets as the server panel data 400. At this time, if information of a panel placed by the player in the past is included, this information is stored as the own panel data 391. Then, the processor 31 places server panels on the basis of the panel data 364.

Next, in step S26, if there is any other player in the stage room, the processor 31 transmits the information of the placed server panels (and possibly own panel data) to the other game apparatuses 3. That is, the information of the server panels is shared with the remote players in the same stage room. For example, if two players enter the room at substantially the same timing and perform server panel-related processing, information of the server panel of one of the players is prioritized.

Next, in step S27, the processor 31 generates a game screen and displays the game screen on the display unit 5. Accordingly, stage play is started.

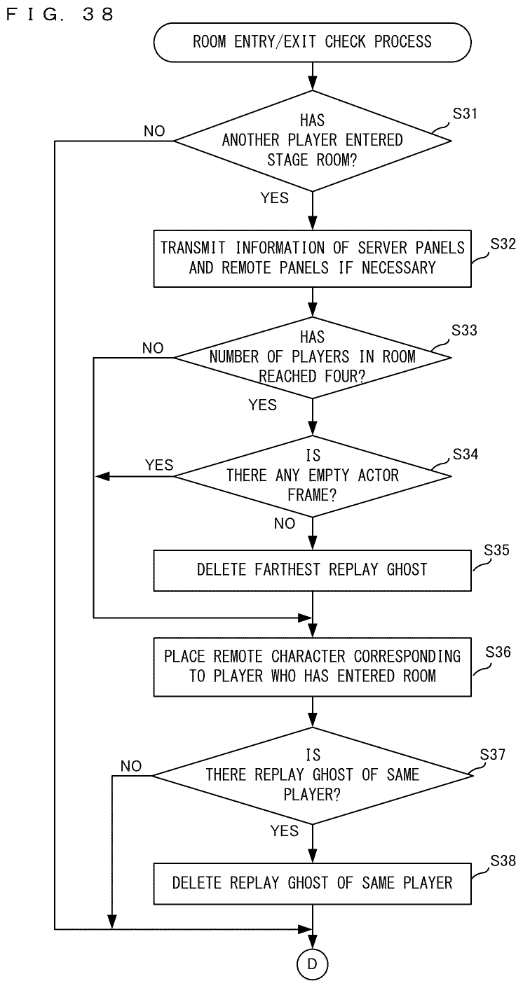

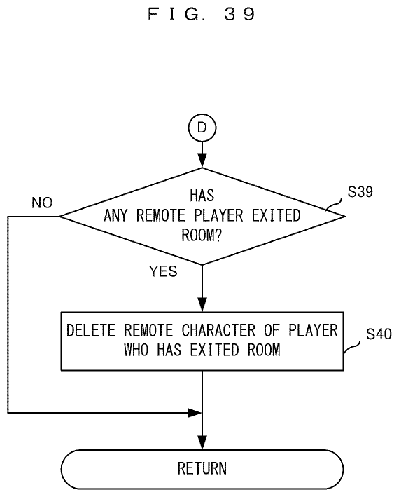

Referring back to FIG. 35, next, in step S2, the processor 31 executes a room entry/exit check process. This is a process for checking the entry and exit of other players that occur after the player has entered the room. FIG. 38 and FIG. 39 are each a flowchart showing the details of the room entry/exit check process. First, in step S31, the processor 31 determines whether or not a new player with no corresponding remote character has entered the room. If, as a result of the determination, there is no new player entering the room (NO in step S31), the processor 31 advances the processing to step S39 described later. On the other hand, if a new player has entered the room (YES in step S31), in step S32, the processor 31 transmits information regarding the server panels and remote panels already installed at that time to the game apparatus 3 of the player who entered the room, if necessary. The process of transmitting this information only needs to be performed by the game apparatus 3 of any one of the players who have already entered the room.

Next, in step S33, the processor 31 determines whether or not the number of players in the room has reached four. If, as a result of the determination, the number of players has not reached four (NO in step S33), the processor 31 advances the processing to step S36 described later. On the other hand, if the number of players has reached four (YES in step S33), in step S34, the processor 31 refers to the player actor management data 363 and determines whether or not there is an empty player actor frame. If, as a result of the determination, there is no empty player actor frame (NO in step S34), it is considered that replay ghosts exist. Therefore, in step S35, the processor 31 deletes the replay ghost located farthest from the player character 201. That is, the processor 31 deletes the data regarding this replay ghost from the replay ghost data 362 and the player actor management data 363. Then, the processor 31 advances the processing to step S36. On the other hand, if, as a result of the determination, there is an empty player actor frame (YES in step S34), the process in step S35 above is skipped.

Next, in step S36, the processor 31 adds the data of a remote character corresponding to the player who entered the room, to the remote character data 361 on the basis of the information received from the game apparatus of the player who entered the room. Then, the processor 31 places the remote character corresponding to the player who entered the room, on the basis of the remote character data 361.

Next, in step S37, the processor 31 determines whether or not a replay ghost of the same player as the remote character placed this time exists. If, as a result of the determination, such a replay ghost exists (YES in step S37), in step S38, the processor 31 deletes the replay ghost of the same player. That is, the processor 31 deletes the data of the replay ghost from the replay ghost data 362. On the other hand, if such a replay ghost of the same player does not exist (NO in step S37), the process in step S38 above is skipped.

Next, in step S39 in FIG. 39, the processor 31 determines whether or not any remote player has exited the room. In addition, in conjunction with this, the processor 31 also determines whether or not reproduction of each replay ghost existing at that time has been completed. If, as a result of the determination, any remote player has exited the room, or the reproduction of the replay ghost has been completed (YES in step S39), in step S40, the processor 31 deletes the remote character related to the player who has exited the room, or deletes the replay ghost whose reproduction has been completed, and the corresponding replay data.

On the other hand, if no remote player has exited the room nor has the reproduction of the replay ghost been completed (NO in step S39), the process in step S40 above is skipped. Then, the processor 31 ends the room entry/exit check process.

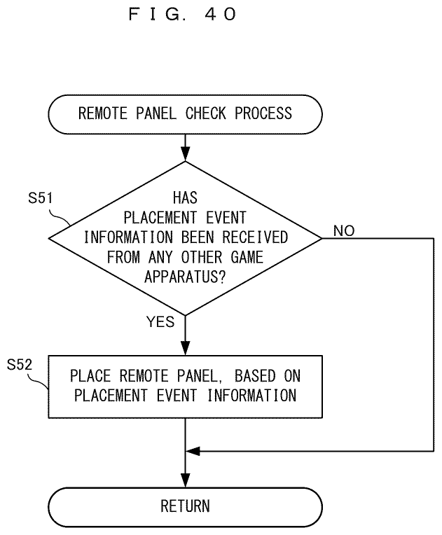

Referring back to FIG. 35, next, in step S3, the processor 31 executes a remote panel check process. This is a process for, when a remote player places a panel, reflecting this in the own game processing. FIG. 40 is a flowchart showing the details of the remote panel check process. First, in step S51, the processor 31 determines whether or not the above placement event information has been received from any other game apparatus 3. If, as a result of the determination, the placement event information has been received (YES in step S51), in step S52, the processor 31 updates the content of the panel data 364 on the basis of this placement event information. For example, when the same player reinstalls a panel, a process of deleting the already installed panel and replacing the data of the already installed panel with the data of the new panel is performed. In addition, when a new panel is installed, data regarding this panel is newly created. Then, the processor 31 installs the remote panel on the basis of the panel data 364 as appropriate. On the other hand, if, as a result of the determination, no placement event information has been received, the process in step S52 above is skipped. Then, the remote panel check process ends.

Referring back to FIG. 35, next, in step S4, the processor 31 refers to the special state flag 356 and determines whether or not the player character 201 is in the special state. If, as a result of the determination, the player character 201 is not in the special state (NO in step S4), in step S5, the processor 31 executes a normal state process. On the other hand, if the player character 201 is in the special state (YES in step S4), in step S6, the processor 31 executes a special state process. Each process will be described below.

### [Process in Normal State]

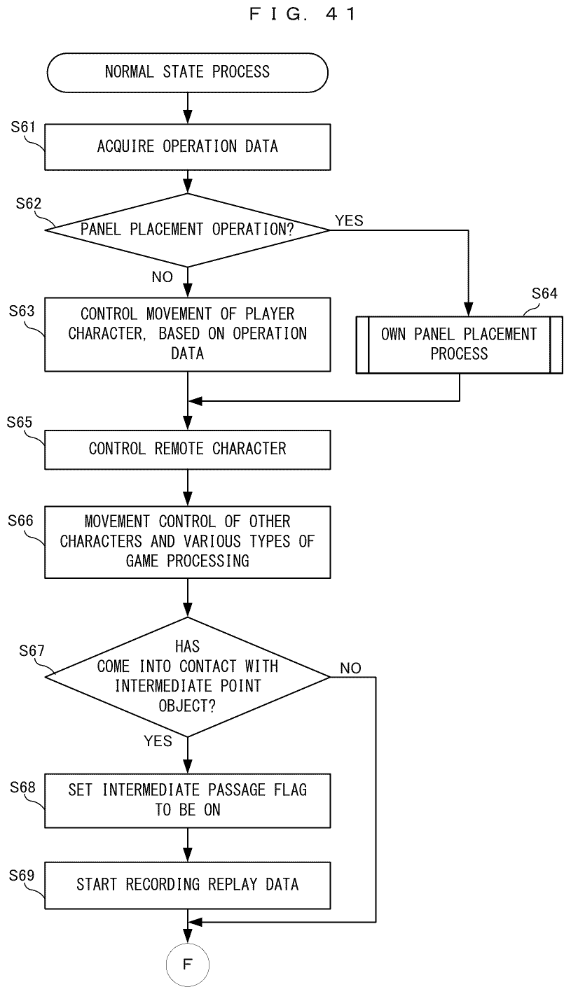

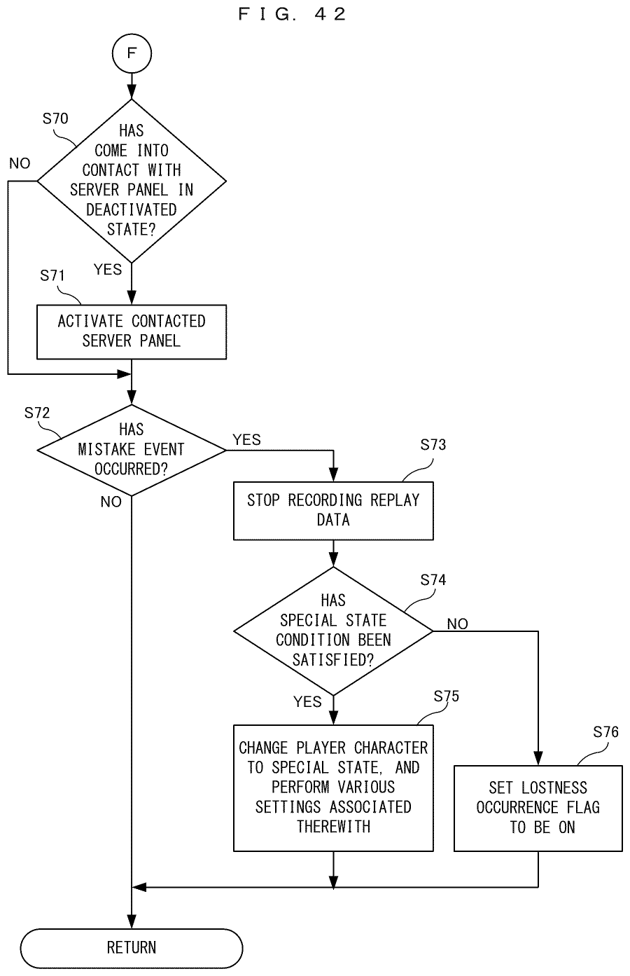

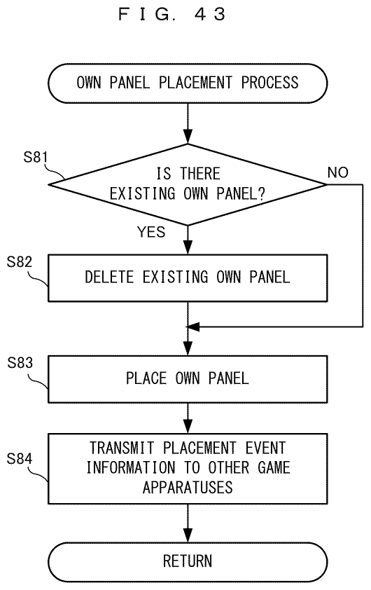

FIG. 41 and FIG. 42 are each a flowchart showing the details of the normal state process. In FIG. 41, first, in step S61, the processor 31 acquires the operation data 365. Next, in step S62, the processor 31 determines whether or not a panel placement operation has been performed. If, as a result of the determination, a panel placement operation has been performed (YES in step S62), in step S64, the processor 31 executes an own panel placement process. FIG. 43 is a flowchart showing the details of the own panel placement process. First, in step S81, the processor 31 refers to the panel data 364 and determines whether or not an existing own panel is present. If an existing own panel is present (YES in step S81), in step S82, the processor 31 deletes the data of the existing own panel from the panel data 364. On the other hand, if no existing own panel is present (NO in step S81), the process in step S82 above is skipped.

Next, in step S83, the processor 31 places an own panel at a position for which the panel placement operation has been performed. That is, the processor 31 generates data regarding the own panel in the panel data 364, and places the own panel in the stage on the basis of this data.

Next, in step S84, the processor 31 generates placement event information regarding the own panel and transmits the placement event information to the other game apparatuses 3. This is the end of the own panel placement process.

Referring back to FIG. 41, if, as a result of the determination in step S62 above, no panel placement operation has been performed (NO in step S62), in step S63, the processor 31 controls the action of the player character 201 on the basis of the operation content indicated by the operation data 365. Furthermore, the processor 31 transmits position information of the player character 201 and state information indicating whether the player character 201 is in the normal state or the special state, to the other game apparatuses 3.

Next, in step S65, the processor 31 receives the information regarding the remote characters from the other game apparatuses 3, and moves the remote characters. The information regarding the remote character is position information of the remote character and information indicating the state of the remote character. Instead of the position information, for example, information of an operation performed by the remote player may be received. In this case, the movement of the remote character may be controlled on the basis of the received information of the operation. In addition, if any replay ghost exists, the processor 31 continues reproduction based on the replay data. Accordingly, the movement of the replay ghost is controlled.

Next, in step S66, the processor 31 controls the actions of enemy characters, etc. Furthermore, the processor 31 performs collision determination between the player character 201 and each enemy character, each remote panel, etc., and executes game processing corresponding to the results thereof, as appropriate. For example, if the player character 201 has come into contact with a remote panel, a process of temporarily displaying the name of the remote player who placed this remote panel is performed. Also, for example, if the player character 201 has come into contact with an enemy character, a process of damaging the enemy character or a process of damaging the player character 201 is performed. In addition, as a result of this game processing, the above-described mistake event can occur.

Next, in step S67, the processor 31 determines whether or not the player character 201 has come into contact with an intermediate point object. If, as a result of the determination, the player character 201 has come into contact with an intermediate point object (YES in step S6), in step S68, the processor 31 sets the intermediate passage flag 358 to be ON. Along with this, the restart point after this is also set to be the position of the intermediate point object. Next, in step S69, the processor 31 starts recording replay data regarding the player character 201 using the replay recording data 359. At this time, in a situation in which restart is made from the intermediate point, control may be performed such that, at a certain probability, recording of replay data is not started as described above.

On the other hand, if, as a result of the determination in step S67 above, the player character 201 has not come into contact with any intermediate point object (NO in step S67), the processes in steps S68 and S69 above are skipped.

Next, in step S70 in FIG. 42, the processor 31 determines whether or not the player character 201 has come into contact with a server panel in a deactivated state. If, as a result of the determination, the player character 201 has come into contact with such a server panel (YES in step S70), in step S71, the processor 31 sets the activation flag 403 for the contacted server panel to be ON. On the other hand, if the player character 201 has not come into contact with such a server panel (NO in step S70), the process in step S71 above is skipped.

Next, in step S72, the processor 31 determines whether or not the above mistake event has occurred. If, as a result of the determination, the mistake event has occurred (YES in step S72), in step S73, the processor 31 stops recording the replay data. Next, in step S74, the processor 31 determines whether or not a condition for the player character 201 to be in the special state has been satisfied. That is, the processor 31 determines whether or not any revival assistance object exists within the predetermined range from the player character 201. If, as a result of the determination, the condition to be in the special state has been satisfied (YES in step S74), in step S75, the processor 31 performs a setting for the player character 201 to be in the special state and various settings associated therewith. Specifically, the processor 31 sets the special state flag 356 to be ON. Furthermore, the processor 31 changes the player character 201 into the special character. Moreover, the processor 31 adds 1 to the special state count 357. Moreover, the processor 31 performs a display setting of the game screen such that the game screen is displayed in monochrome except for the revival assistance object. Then, the normal state process ends.

On the other hand, if the condition to be in the special state has not been satisfied (NO in step S74), in step S76, the processor 31 sets the lostness occurrence flag 360 to be ON. Then, the normal state process ends.

On the other hand, if, as a result of the determination in step S72 above, no mistake event has occurred (NO in step S70), the normal state process ends.

### [Process in Special State]

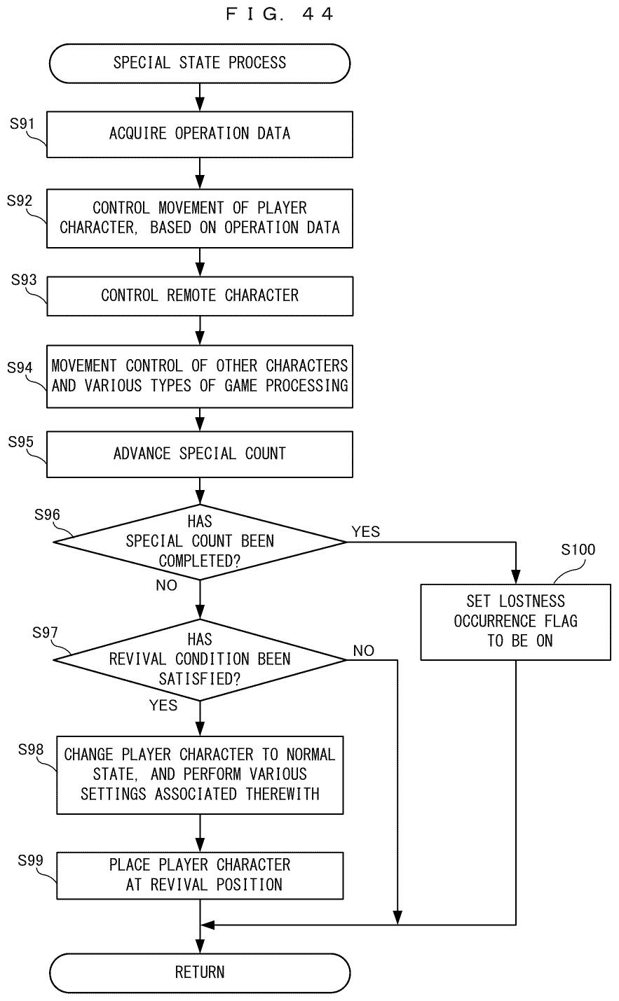

Next, the special state process will be described. FIG. 44 is a flowchart showing the details of the special state process. First, in step S91, the processor 31 acquires the operation data 365. Next, in step S92, the processor 31 moves the special character on the basis of the operation data 365. As described above, while the player character 201 is the special character, collision determination with terrain and each enemy character is not performed.

Next, in step S93, the processor 31 controls each remote character. While the player character 201 is in the special state, control is performed such that the remote character is displayed in an opaque manner rather than in a semi-transparent manner as described above. In addition, control is performed such that collision determination between the remote character and the special character is performed. Moreover, if any replay ghost exists, the replay ghost is also controlled in the same manner as the remote character.

Next, in step S94, the processor 31 controls the actions of each enemy character, etc., and performs various types of game processing associated therewith.

Next, in step S95, the processor 31 advances the count of the special counter for counting the time for which revival from the special state is possible. At this time, the processor 31 advances the count after changing the time interval for one count as appropriate on the basis of the special state count 357.

Next, in step S96, the processor 31 determines whether or not the count of the special counter has been completed. If, as a result of the determination, the count has not yet been completed (NO in step S96), in step S97, the processor 31 determines whether or not a revival condition has been satisfied. That is, the processor 31 determines whether or not the special character has come into contact with any revival target object within the above revivable time. If, as a result of the determination, the revival condition has been satisfied (YES in step S97), in step S98, the processor 31 sets the special state flag 356 to be OFF. Furthermore, the processor 31 changes the special character into the player character 201 in the normal state. Furthermore, the processor 31 cancels the monochrome display setting of the game screen and sets the game screen to be displayed normally. Next, in step S99, the processor 31 places the player character 201 at a predetermined revival position. To determine the revival position, for example, a ray is cast from the contacted revival target object toward the special character, and it is determined whether or not the ray comes into contact with any terrain. If the ray has come into contact with any terrain, the position of the revival assistance object is set as the revival position. If the ray has not come into contact with any terrain, the position of the special character is set as the revival position. Accordingly, the position shown in FIG. 13 to FIG. 18 above is determined as the revival position. However, as shown in FIG. 19 above, if both the special character and the revival target object are within the terrain, a search is made for a revival position by moving the above search pointer in a spiral manner. If an enemy character or the like exists at the above determined or searched revival position, the revival position may be shifted to a position where contact with the enemy character or the like does not occur. That is, a position at which no mistake event occurs immediately after the player character 201 is returned to the normal state may be determined as the revival position, and the player character 201 may be placed at this position.

In determining the revival position, the size of the player character 201 returned to the normal state is also taken into consideration. That is, a position at which a sufficient space in which the player character 201 returned to the normal state is not stuck in an obstacle or the like is ensured is determined as the revival position. For example, a position such as a gap between obstacles at which a player character having a small size can be placed but there is an insufficient space for a player character having a large size, is assumed. In this case, even if such a gap position is found, if it is determined that there is no sufficient space in consideration of the size of the player character, a search for another position is continued. On the other hand, if it is determined that there is a sufficient space, this gap position is determined as the revival position.

On the other hand, if, as a result of the determination in step S96 above, the count of the special counter has been completed (YES in step S96), in step S100, the processor 31 sets the lostness occurrence flag 360 to be ON. Then, the special state process ends.

Referring back to FIG. 35, next, in step S7, the processor 31 determines whether or not the lostness occurrence flag 360 is ON. If the lostness occurrence flag 360 is not ON (NO in step S7), in step S8, the processor 31 determines whether or not the player character 201 has already come into contact with any intermediate point object, on the basis of the intermediate passage flag 358. If, as a result of the determination, the player character 201 has not yet come into contact with any intermediate point object (NO in step S8), the processor 31 advances the processing to step S10 described later. On the other hand, if the player character 201 has already come into contact with any intermediate point object (YES in step S8), in step S9, the processor 31 executes a replay ghost process.

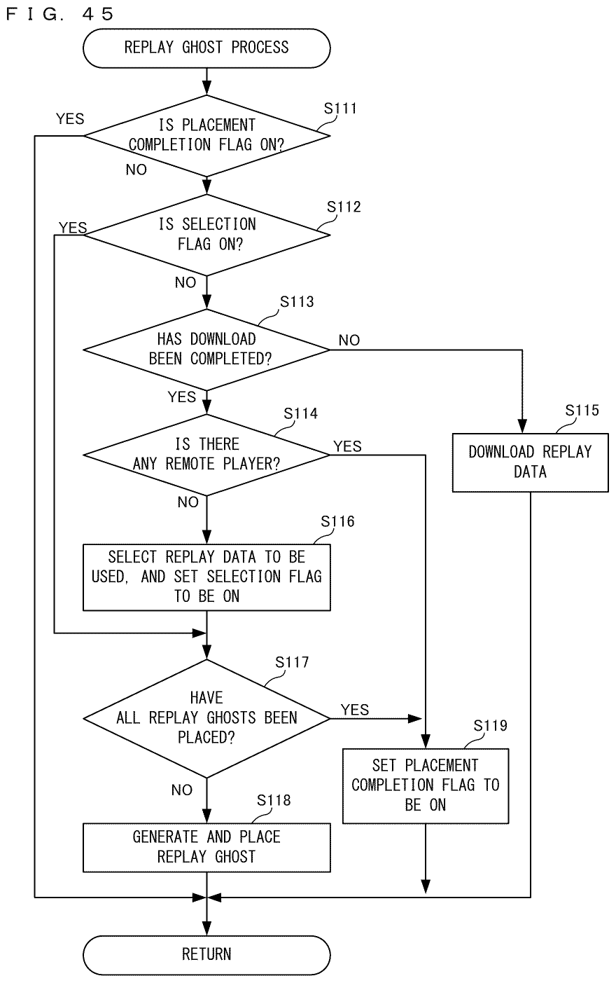

FIG. 45 is a flowchart showing the details of the replay ghost process. First, in step S111, the processor 31 determines whether or not the placement completion flag 367 is ON. If the placement completion flag 367 is ON (YES in step S111), the processor 31 ends the replay ghost process. On the other hand, if the placement completion flag 367 is OFF (NO in step S111), in step S112, the processor 31 determines whether or not the selection flag 366 is ON. If the selection flag 366 is ON (YES in step S112), the processor 31 advances the processing to step S117 described later. If the selection flag 366 is OFF (NO in step S112), in step S113, the processor 31 determines whether or not download of replay data from the game server 1 has been completed. If, as a result of the determination, the download has not been completed (NO in step S113), in step S115, the processor 31 starts downloading the replay data from the game server 1. Alternatively, if the download of the replay data has already been started, the processor 31 continues the download. Then, the replay ghost process ends.

On the other hand, if the download of the replay data has been completed (YES in step S113), next, in step S114, the processor 31 determines whether or not any remote player exists at this time. If, as a result of the determination, any remote player exists (YES in step S114), in step S119, the processor 31 sets the placement completion flag 367 to be ON. In this case, for example, when a remote player enters the room during the download, even if the download of the replay data is completed, actual placement of the replay ghost is not performed. Then, the replay ghost process ends.

On the other hand, if no remote player exists (NO in step S114), in step S116, the processor 31 randomly selects up to three replay data from the downloaded replay data, as replay data to be used as replay ghosts. At this time, the own replay data is excluded from the selection targets. Then, the processor 31 sets the selection flag 366 to be ON.

Next, in step S117, the processor 31 determines whether or not all the selected replay ghosts have been placed in the stage. If not all the selected replay ghosts have been placed in the stage (NO in step S117), in step S118, the processor 31 generates one replay ghost and places the replay ghost in the stage. At this time, control is performed such that, as described above, one replay ghost is placed at one time while shifting the timing of placement slightly.

On the other hand, if all the selected replay ghosts have been placed in the stage (YES in step S117), the processor 31 advances the processing to step S119 above, and sets the placement completion flag 367 to be ON. Then, the replay ghost process ends.

Next, in step S10 in FIG. 36, the processor 31 determines whether or not the player character 201 has reached the goal. If, as a result of the determination, the player character 201 has not reached the goal (NO in step S10), in step S11, the processor 31 generates and displays a game screen in which the above processing is reflected. Then, the processor 31 returns to step S2 above and repeats the processing.

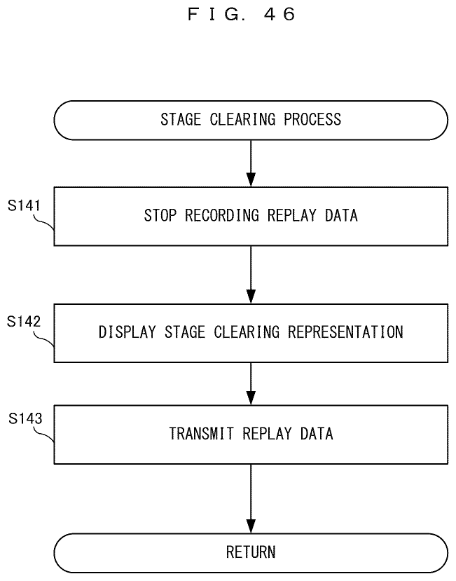

On the other hand, if the player character 201 has reached the goal (YES in step S10), in step S12, the processor 31 executes a stage clearing process. FIG. 46 is a flowchart showing the details of the stage clearing process. First, in step S141, the processor 31 stops recording the replay data to the replay recording data 359. Next, in step S142, the processor 31 displays a stage clearing representation. Next, in step S143, the processor 31 transmits the replay recording data 359 to the game server 1. Then, the processor 31 ends the stage clearing process.

Referring back to FIG. 36, next, in step S13, if the own panel placed by the processor 31 remains in the stage, the processor 31 transmits the own panel data 391 to the game server 1.

Next, in step S14, the processor 31 performs a process of exiting the stage room. Then, the stage play processing ends.

Next, processing performed if, as a result of the determination in step S7 above, the lostness occurrence flag 360 is ON (YES in step S7) will be described. In this case, first, in step S15, the processor 31 decreases the remaining number of player characters 201 by 1. Next, in step S16, the processor 31 determines whether or not the remaining number of player characters 201 is 0. If, as a result of the determination, the remaining number of player characters 201 is not 0 (NO in step S16), the processor 31 executes a restart process in step S17.

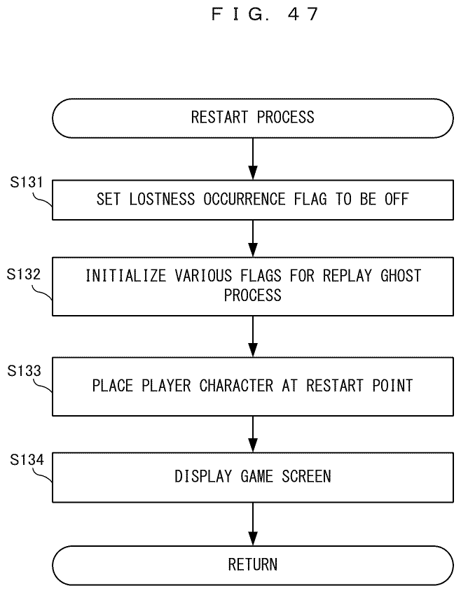

FIG. 47 is a flowchart showing the details of the restart process. In FIG. 47, first, in step S131, the processor 31 sets the lostness occurrence flag 360 to be OFF. At this time, the processor 31 also sets the special state count 357 to 0. That is, along with the restart, the processor 31 resets the count of the number of times of change to the special state. In this regard, in another exemplary embodiment, the special state count 357 may be adopted after the restart, without being reset.

Next, in step S132, the processor 31 initializes the selection flag 366 and the placement completion flag 367. Accordingly, when restart is made from the intermediate point, download of replay data and placement of a new replay ghost can be performed again.

Next, in step S133, the processor 31 places the player character 201 at a predetermined restart point. In addition, in conjunction with this, a virtual camera is also moved to a position at which the player character 201 is within an imaging range thereof. Next, in step S134, the processor 31 generates and displays a game screen. This is the end of the restart process.

Referring back to FIG. 36, after the restart process ends, the processor 31 returns to step S2 above and repeats the processing.

On the other hand, if, as a result of the determination in step S16 above, if the remaining number of player characters 201 is 0 (YES in step S16), in step S18, the processor 31 displays a game-over representation. Then, the processor 31 advances the processing to step S13 above. In this case, the flow of the game is from transmission of the information of the own panel to the game server 1 to exit from the stage room.

This is the end of the detailed description of the stage play processing.

### [Processing of Game Server 1]

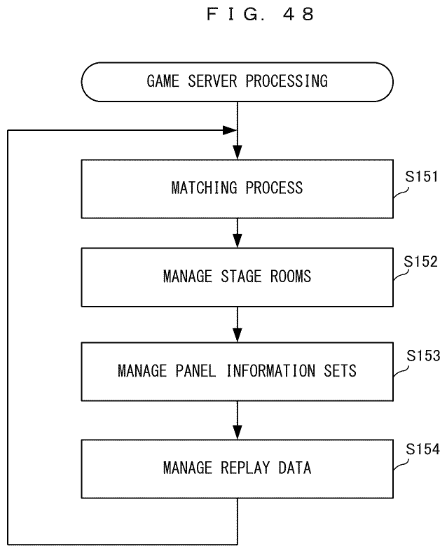

Next, the details of processing executed in the game server 1 will be described. FIG. 48 is a flowchart showing the details of the processing in the game server 1. In FIG. 48, first, in step S151, the processor 11 of the game server 1 executes a matching process. In this process, in response to a request from a player to start stage play, a process of matching between players, that is, determining a stage room that each player will enter, is executed. A process of transmitting the result of the process to each game apparatus 3 is also executed.

Next, in step S152, the processor 31 performs a process of managing each stage room. In this process, a process of updating the stage room management data 304 as appropriate and managing each stage room, such as creating a new room, replenishing with players, and deleting a room in which players are no longer present, is performed.

Next, in step S153, the processor 31 executes a process of managing panel information sets. In this process, the processor 31 receives the own panel data 391 transmitted from each game apparatus 3, registers the own panel data 391 in the panel management data 306, and updates the panel management data 306. In addition, if necessary, a process of transmitting the panel information set 332, which is the basis of the server panel, is also executed in response to a request from a predetermined game apparatus 3.

Next, in step S154, the processor 31 performs a process of managing replay data. In this process, registration in and update of the replay management data 305 are performed on the basis of the replay data received from each game apparatus 3.

Then, the processor 11 returns to step S151 above and repeats the processing. This is the end of the detailed description of the processing in the game server 1.

As described above, in the exemplary embodiment, when a mistake event occurs for the player character 201, if a remote character which is a revival assistance object is present nearby, the player character 201 is changed to the special state without causing lostness for the player character 201. Then, the player character 201 can be revived to the normal state by coming into contact with the remote character within the revivable time. Accordingly, it is possible to provide the benefits of playing online to the player while advancing the game as if it were a single-player game. Therefore, it is possible to promote online multiplayer game play.

In addition, not only the remote characters, but also the remote panels placed by the remote characters and the above server panels can function as the revival assistance objects. Therefore, if one player places a remote panel, the player can expect that, instead of the player, this remote panel will serve as help to another player. This prevents, for example, one player from becoming so conscious of assisting in revival of another player that the one player cannot advance the game at their own pace.

In the exemplary embodiment, as described above, a replay ghost is caused to appear in response to passing an intermediate point in a stage. The replay ghost is indistinguishable from the above remote character at a glance. The replay ghost also functions as the revival assistance object. Therefore, even if a player does not encounter any other player until the middle of the stage, the player is connected online with other players in the second half of the stage, and an experience of playing together in the same stage room can be provided to the player. That is, from the start of stage play until the intermediate point is reached, the expectation of meeting other players is given to the player. For example, in the first half of the stage, it is quite possible that the remote character of another player who entered the room later will catch up with the player. Therefore, no ghost is caused to appear immediately after the start of stage play, but the player is caused to wait for a while for other players to enter the room and for remote characters to appear. Meanwhile, if no other player enters the room even after the intermediate point is reached from the start of stage play, a replay ghost is caused to appear, thereby providing a play experience as if the player were advancing through the stage together with a remote character. This gives meaning to playing online and encourages players to actively play online. In addition, if any other player enters the room after the replay ghost appears, the replay ghost is deleted and a remote character(s) is caused to appear according to the number of players who entered the room. Therefore, it is possible to prioritize play with remote characters with which it is possible to communicate.

### Modifications

As for the replay ghost, for example, it is possible that a character that is the same as the character used by the player as the player character 201 is selected as the replay ghost. In this case, the appearance of the character as the replay ghost may be changed to the appearance of another character. This is to suppress unnecessary confusion for the player, since, if there is a replay ghost that is the same character as the player character 201, it is difficult to distinguish between the replay ghost and the player character 201 in some cases.

In the above example, as the timing for the replay ghost to appear, the timing when the player character reaches the intermediate point is exemplified. In this regard, in a certain stage, a replay ghost may be caused to appear from the start point. In this case, in this certain stage, recording of replay data may also be started from the start point.

In the above example, the case where the appearance of the replay ghost is the same as that of the remote character has been illustrated. In this regard, in another exemplary embodiment, the appearance of the replay ghost may be different from that of the remote character such that the player can distinguish therebetween.

In the above example, the example in which no replay ghost is caused to appear (replay is not reproduced) if a remote character exists has been described. In another exemplary embodiment, even if a remote character exists, a replay ghost may be caused to appear. For example, replay ghosts whose number is equal to the vacancy for the capacity of the stage room may be caused to appear. Furthermore, in this case, the information of a replay ghost caused to appear in any game apparatus may be shared with the other game apparatuses. For example, if a process of causing a replay ghost to appear in the game processing of a game apparatus A is performed, the position information of the replay ghost may be shared, or replay data itself may be shared, so that the same replay ghost may be caused to appear in the other game apparatuses in the same stage room.

In the above embodiment, the example in which the player character 201 changes to the special state when a mistake event occurs under a predetermined condition has been described. In this regard, in another exemplary embodiment, the player may be able to voluntarily change the player character 201 to the special state by performing a predetermined operation. However, the revival from the special state to the normal state may not necessarily be able to be performed by a voluntary operation, and for the revival, it may be necessary to come into contact with the revival assistance object within the revivable time as described above. Accordingly, the player is allowed to play such that the player character 201 is strategically and deliberately brought into the special state to go through difficult spots on the stage and is then revived in order to conquer the stage. Therefore, it is possible to expand the range of play while maintaining the benefits of online play.

As for the remote panel, in another exemplary embodiment, control may be performed such that a remote panel placed by a player who exited a room is automatically deleted when a predetermined time elapses after the exit from the room.

As for the timing of transmitting the panel information set to the game server 1, in the above example, the panel information set is transmitted when the player exits the stage room. In another exemplary embodiment, the panel information set may be transmitted to the game server 1 each time placement is performed. In addition, it may be possible to register a plurality of panel information sets for the same player in the game server 1.

In the above embodiment, the example in which collision determination between the player character 201 in the normal state and the remote character is not performed, has been described. In this regard, in another exemplary embodiment, a process in which collision determination itself is performed but the remote character does not directly affect game play by the player, may be performed. For example, when the player character 201 in the normal state comes into contact with the remote character (displayed in a semi-transparent manner), a process of temporarily displaying a remote player name for the remote character while displaying a representation that the remote character is pushed slightly as a reaction, may be performed.

In the above embodiment, the case where the number of players playing on each game apparatus is one is assumed. In this regard, for example, two players may be able to simultaneously participate in stage play on one game apparatus. For example, in the case where a player A and a player B play simultaneously together (in a local multiplayer mode) on a game apparatus A, a player character A and a player character B which are player characters of the respective players may be displayed on the same game screen. In this case, the player character A and the player character B may not necessarily be displayed in a semi-transparent manner as in the case of remote characters, and may be both displayed in an opaque manner. In addition, the player character A and the player character B may function as revival assistance objects for each other. As for the panel placement, panels placed by both players may be treated as the remote panels. Alternatively, only a panel placed by one of the player characters may be treated as the remote panel.

In the case of the local multiplayer mode as described above, as for the panel information set transmitted to the server, only the panel information set of the panel placed by one of the players may be transmitted. As for the above-described server panel, up to two server panels may be placed.

As for the replay ghost, since the number of player actors is adjusted to up to four in one room, up to two replay ghosts may be placed.

When all the player characters in a local multiplayer mode are no longer in the normal state, if there is no special character, the above lostness occurs for each player character in the local multiplayer mode at that time. On the other hand, if any of the player characters is the special character, the lostness does not occur at that time. This is because, for example, there is a possibility that the player character can be revived by the above remote character or remote panel.

In the above embodiment, while the player character is the special character, the player character can be revived without decreasing the remaining number of player characters if the player character can come into contact with the revival assistance object within the revivable time. In this regard, in another exemplary embodiment, the player character may be revived with a decrease in the remaining number of player characters. In this case as well, the position where the player character is revived is close to the revival assistance object, which is more advantageous to the player than in the case where the player character is returned to the restart point and revived.

While the present disclosure has been described in detail, the foregoing description is in all aspects illustrative and not restrictive. It is to be understood that numerous other modifications and variations can be devised without departing from the scope of the present disclosure.

What is claimed is:

1. A non-transitory computer-readable storage medium having stored therein a game program executed by a processor of a game apparatus for executing a process of generating a game stage including a player object controllable to move on the basis of an operation by a player and another player object controlled to move on the basis of information received from another game apparatus connected via a network, the game program causing the processor to:
when a mistake occurs in a predetermined game stage, shift the player object to a special state where the player object does not become damaged in the game stage;
return the player object from the special state to a normal state where the player object can become damaged in the game stage, without terminating play of the game stage, if the player object comes into contact with any revival assistance object including the other player object and a placement object placed in the game stage by the other player object, while the player object is in the special state; and
terminate the play of the game stage if the player object has not come into contact with any revival assistance object while the player object is in the special state.

2. The storage medium according to claim 1, wherein the player object is not returned to the normal state if the player object in the special state comes into contact with the placement object placed by the player object.

3. The storage medium according to claim 1, wherein the game program further causes the processor to:
transmit placement information including at least position information of the placement object, to the predetermined server when the player object places the placement object; and
place the placement object based on the placement information stored in the predetermined server, in the game stage, and
the revival assistance object includes the placement object placed on the basis of the placement information stored in the predetermined server.

4. The storage medium according to claim 3, wherein the placement object placed on the basis of the placement information stored in the predetermined server does not function as the revival assistance object when placed, and a function of the placement object as the revival assistance object is activated when the player object comes into contact with the placement object.

5. The storage medium according to claim 3, wherein, at a predetermined timing, when no placement object exists in the game stage, the placement object based on the placement information stored in the predetermined server is placed in the game stage.

6. The storage medium according to claim 1, wherein the game program further causes the processor to:
determine whether or not the revival assistance object exists within a predetermined range from the player object, when a mistake occurs in the predetermined game stage; and
shift the player object to the special state where the player object does not become damaged in the game stage, if it is determined that the revival assistance object exists within the predetermined range from the player object.

7. The storage medium according to claim 6, wherein
the player object is operable while being in the special state,
a state where the player object is in the special state continues for a predetermined time, and
the play of the game stage is terminated if the player object has not come into contact with the revival assistance object within the predetermined time after the player object is shifted to the special state.

8. The storage medium according to claim 7, wherein, when the shift to the special state occurs in the same game stage a plurality of times, the predetermined time is gradually shortened as the number of times of the shift to the special state increases.

9. The storage medium according to claim 6, wherein
the game program further causes the processor to cause a ghost character to appear in the game stage, the ghost character acting on the basis of replay data for replaying a play content of another player, and
the revival assistance object includes the ghost character related to the other player in addition to the other player object.

10. The storage medium according to claim 9, wherein the game program further causes the processor to:
record an action content of the player object in a predetermined period as the replay data and transmit the replay data to a predetermined server at a predetermined timing;
acquire the replay data transmitted by another player, from the predetermined server at a predetermined timing after the play of the game stage by the player is started; and
cause the ghost character to act on the basis of the replay data acquired from the predetermined server.

11. The storage medium according to claim 6, wherein the other player object does not affect the player object in the normal state.

12. The storage medium according to claim 11, wherein the other player object is displayed in a semi-transparent manner when the player object is in the normal state, and is displayed in an opaque manner when the player object is in the special state.

13. The storage medium according to claim 12, wherein, when the player object is in the special state, a game screen is displayed such that a saturation of the game stage is decreased except for the revival assistance object.

14. The storage medium according to claim 1, wherein, when the player object is returned to the normal state, the player object in the normal state is placed at a position where the mistake does not occur immediately after the player object is returned to the normal state.

15. A game system for executing a process of generating a game stage including a player object controllable to move on the basis of an operation by a player and another player object controlled to move on the basis of information received from another game apparatus connected via a network, the game system comprising a processor and a memory coupled thereto, the processor being configured to control a processing system to at least:
when a mistake occurs in a predetermined game stage, shift the player object to a special state where the player object does not become damaged in the game stage;
return the player object from the special state to a normal state where the player object can become damaged in the game stage, without terminating play of the game stage, if the player object comes into contact with any revival assistance object including the other player object and a placement object placed in the game stage by the other player object, while the player object is in the special state; and
terminate the play of the game stage if a predetermined condition is satisfied without the player object coming into contact with any revival assistance object while the player object is in the special state.

16. A game processing method executed by a processor of a game system for executing a process of generating a game stage including a player object controllable to move on the basis of an operation by a player and another player object controlled to move on the basis of information received from another game apparatus connected via a network, the game program causing the processor to:
when a mistake occurs in a predetermined game stage, shift the player object to a special state where the player object does not become damaged in the game stage;
return the player object from the special state to a normal state where the player object can become damaged in the game stage, without terminating play of the game stage, if the player object comes into contact with any revival assistance object including the other player object and a placement object placed in the game stage by the other player object, while the player object is in the special state; and
terminate the play of the game stage if a predetermined condition is satisfied without the player object coming into contact with any revival assistance object while the player object is in the special state.
